(19) United States
(12) Patent Application Publication
(10) Pub. No.: US 2026/0197131 A1
(43) Pub. Date: Jul. 9, 2026

(54) DATA TRANSMISSION METHOD AND DEVICE, AND STORAGE MEDIUM

(71) Applicant: ZTE CORPORATION, Shenzhen, Guangdong (CN)

(72) Inventors: Zhigang Li, Shenzhen, Guangdong (CN); Zhifeng Yuan, Shenzhen, Guangdong (CN); Weimin Li, Shenzhen, Guangdong (CN); Yihua Ma, Shenzhen, Guangdong (CN)

(21) Appl. No.: 19/131,512

(22) PCT Filed: Nov. 30, 2023
(86) PCT No.: PCT/CN2023/135624

§ 371 Date: May 20, 2025

(30) Foreign Application Priority Data
Dec. 5, 2022 (CN) 202211551808.X

(51) Int. Cl. H04L 5/00; H04J 13/00

(52) U.S. Cl. CPC H04L 5/0048; H04J 13/0062

(57) ABSTRACT

Provided is a data transmission method and device, and a storage medium. The data transmission method includes acquiring N pilot sequences and a spreading sequence, where at least one pilot sequence among the N pilot sequences has an association relationship with the spreading sequence, and N is an integer greater than 1; processing to-be-sent data by using the spreading sequence to generate a to-be-sent data symbol; and sending the N pilot sequences and the to-be-sent data symbol.

### TECHNICAL FIELD

The present application relates to the field of wireless communications, for example, a data transmission method and device, and a storage medium.

### BACKGROUND

The fifth-generation mobile communication (5G) proposes grant-free data transmission technology, and the terminal may use grant-free transmission resources for data transmission. For the grant-free transmission scheme, the terminal may send data autonomously, and the base station does not need to send a scheduling request or wait for dynamic scheduling. Therefore, grant-free transmission can reduce the signaling overhead, the transmission delay, and the terminal power consumption. Additionally, grant-free transmission may also be combined with non-orthogonal transmission to increase the number of access users.

Grant-free transmission includes two schemes: pre-configured grant-free transmission and contention-based grant-free transmission. For contention-based grant-free transmission, when a service arrives at the terminal, the terminal may randomly select transmission-related resources, including time-frequency resources, pilot sequences, and spreading sequences, for contention-based access and transmission. Due to the lack of coordination by the base station, the resources used by multiple terminals may collide, and the receiver needs to use more complex or advanced blind detection algorithms to achieve multi-user identification and detection. Contention-based grant-free transmission is more suitable for random burst services, offering better transmission efficiency and lower delay.

Usually, the contention-based grant-free transmission includes two parts: a pilot part and a data part. The pilot includes a preamble, a reference signal, or the like. The terminal may use the spreading sequence to spread the modulated data symbol before sending the modulated data symbol. The use of the spreading sequence can improve the terminal transmission performance, increase the number of access terminals, and suppress the inter-cell interference. However, for contention-based grant-free transmission, the receiver does not know which terminals perform accessing this time, nor does it know the pilot sequences sent by these terminals, the spreading sequences used by these terminals, and the like. Therefore, the terminal may carry user identity information in the data part and establish an association relationship between the pilot and the spreading sequence. The receiver performs pilot detection and according to the identified pilot sequence, determines the spreading sequence used by the terminal, thereby completing user detection. Further, the receiver may determine the user identity through the user identity information carried in the data part.

In the traditional contention-based grant-free transmission, the terminal sends one pilot at a time. The pilot may be formed by a pilot sequence. Therefore, a one-to-one or many-to-one relationship may be established between the pilot sequence and the spreading sequence. The terminal may determine the spreading sequence according to a randomly selected pilot sequence and spread the modulated data symbol. According to the identified pilot sequence, the receiver determines the spreading sequence used by the terminal, thereby completing user detection.

For contention-based grant-free transmission, pilot collision is an important factor that limits the number of access users and system performance. To reduce the pilot collision probability, multiple pilots may be designed on the basis of the traditional one/single pilot-based scheme. The contention-based grant-free scheme based on multiple pilots can significantly reduce the pilot collision probability, increase the number of access users, and improve the system performance. However, unlike a single pilot, it is difficult to establish a simple one-to-one or many-to-one association relationship between multiple pilots and the spreading sequences, making user detection difficult.

### SUMMARY

In view of this, embodiments of the present application are expected to provide a data transmission method and device, and a storage medium.

In a first aspect, an embodiment of the present application provides a data transmission method. The data transmission method includes the following:

N pilot sequences and a spreading sequence are acquired, where at least one pilot sequence among the N pilot sequences has an association relationship with the spreading sequence, and N is an integer greater than 1.

To-be-sent data is processed by using the spreading sequence to generate a to-be-sent data symbol.

The N pilot sequences and the to-be-sent data symbol are sent.

In a second aspect, an embodiment of the present application provides a data transmission method. The data transmission method includes the following: N pilots and a data symbol are received, where N is an integer greater than 1.

At least one pilot among the N pilots is detected to identify at least one pilot sequence sent by a transmitter.

A spreading sequence used by the transmitter is determined according to the identified at least one pilot sequence, where at least one pilot sequence among pilot sequences corresponding to the N pilots has an association relationship with the spreading sequence.

The received data symbol is detected by using the spreading sequence to acquire a detection result.

In a third aspect, an embodiment of the present application provides a data transmission device. The data transmission device includes a memory configured to store a program; and a processor configured to execute the program which, when executed by the processor, causes the processor to perform the data transmission method in the first aspect.

In a fourth aspect, an embodiment of the present application provides a data transmission device. The data transmission device includes a memory configured to store a program; and a processor configured to execute the program which, when executed by the processor, causes the processor to perform the data transmission method in the second aspect.

In a fifth aspect, an embodiment of the present application provides a non-volatile storage medium. The storage medium includes a stored program. When the program is executed, the data transmission method in the first aspect is performed.

In a sixth aspect, an embodiment of the present application provides a non-volatile storage medium. The storage medium includes a stored program. When the program is executed, the data transmission method in the second aspect is performed.

### BRIEF DESCRIPTION OF DRAWINGS

FIG. 1 is a flowchart of a data transmission method according to an embodiment of the present application.

FIG. 2 is schematic diagram one illustrating the association relationship between pilot sequences and spreading sequences according to first embodiment of the present application.

FIG. 3 is schematic diagram two illustrating the association relationship between pilot sequences and spreading sequences according to first embodiment of the present application.

FIG. 4 is schematic diagram three illustrating the association relationship between pilot sequences and spreading sequences according to first embodiment of the present application.

FIG. 5 is schematic diagram four illustrating the association relationship between pilot sequences and spreading sequences according to first embodiment of the present application.

FIG. 6 is schematic diagram five illustrating the association relationship between pilot sequences and spreading sequences according to first embodiment of the present application.

FIG. 7 is schematic diagram one illustrating the association relationship between pilot sequences and spreading sequences according to second embodiment of the present application.

FIG. 8 is schematic diagram two illustrating the association relationship between pilot sequences and spreading sequences according to second embodiment of the present application.

FIG. 9 is schematic diagram three illustrating the association relationship between pilot sequences and spreading sequences according to second embodiment of the present application.

FIG. 10 is schematic diagram one illustrating the association relationship between pilot sequences and spreading sequences according to third embodiment of the present application.

FIG. 11 is schematic diagram two illustrating the association relationship between pilot sequences and spreading sequences according to third embodiment of the present application.

FIG. 12 is schematic diagram three illustrating the association relationship between pilot sequences and spreading sequences according to third embodiment of the present application.

FIG. 13 is schematic diagram one illustrating the association relationship between pilot sequences and spreading sequences according to fourth embodiment of the present application.

FIG. 14 is schematic diagram two illustrating the association relationship between pilot sequences and spreading sequences according to fourth embodiment of the present application.

FIG. 15 is schematic diagram one illustrating the association relationship between pilot sequences and spreading sequences according to fifth embodiment of the present application.

FIG. 16 is schematic diagram two illustrating the association relationship between pilot sequences and spreading sequences according to fifth embodiment of the present application.

FIG. 17 is schematic diagram three illustrating the association relationship between pilot sequences and spreading sequences according to fifth embodiment of the present application.

FIG. 18 is schematic diagram one illustrating the association relationship between pilot sequences and spreading sequences according to sixth embodiment of the present application.

FIG. 19 is schematic diagram two illustrating the association relationship between pilot sequences and spreading sequences according to sixth embodiment of the present application.

FIG. 20 is schematic diagram one illustrating the association relationship between pilot sequences and spreading sequences according to seventh embodiment of the present application.

FIG. 21 is schematic diagram one illustrating the association relationship between pilot sequences and spreading sequences according to eighth embodiment of the present application.

FIG. 22 is a flowchart of another data transmission method according to an embodiment of the present application.

FIG. 23 is a diagram illustrating the structure of a data transmission apparatus according to an embodiment of the present application.

FIG. 24 is a diagram illustrating the structure of another data transmission apparatus according to an embodiment of the present application.

FIG. 25 is a diagram illustrating the structure of a data transmission device according to an embodiment of the present application.

FIG. 26 is a diagram illustrating the structure of another data transmission device according to an embodiment of the present application.

### DETAILED DESCRIPTION

To make the objects, technical solutions, and beneficial effects of the present application more apparent, the embodiments of the present application are described below in conjunction with the drawings. It is to be noted that if not in collision, the embodiments of the present application and the features thereof may be combined with each other.

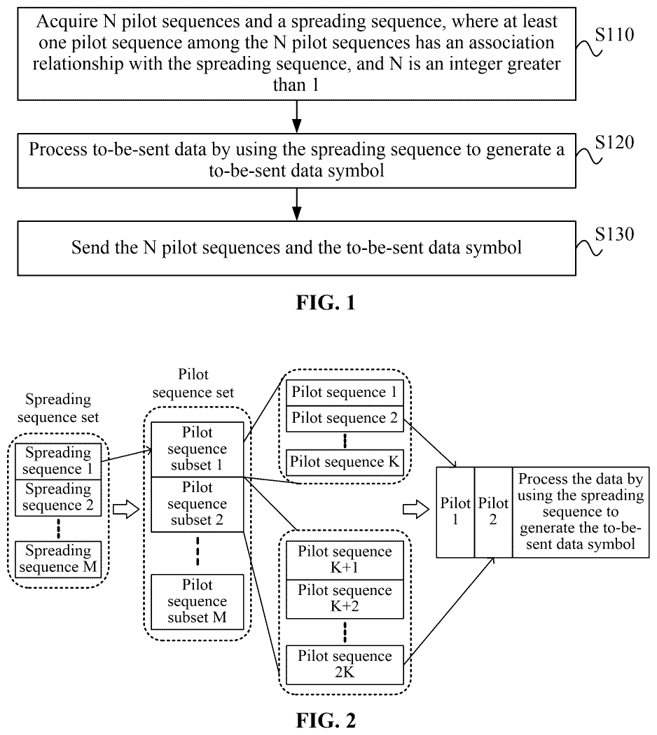

FIG. 1 is a flowchart of a data transmission method according to an embodiment of the present application. As shown in FIG. 1, the data transmission method provided in this embodiment includes the following:

In S110, N pilot sequences and a spreading sequence are acquired, at least one pilot sequence among the N pilot sequences has an association relationship with the spreading sequence, and Nis an integer greater than 1.

The data transmission method provided in this embodiment is used for data transmission and is performed by a data transmitter in the network. The transmitter may be a user, a user equipment (UE), a terminal, a transmitter, or the like. The transmitter may use contention-based resources to perform uplink grant-free data transmission. The data transmission method provided in this embodiment is used for implementing contention-based grant-free transmission based on the combination of multiple pilots and the spreading sequence.

Traditional grant-free transmission is based on a single pilot, but the design of the single pilot for contention-based grant-free transmission has a relatively high pilot collision probability. To reduce the pilot collision probability, a contention-based grant-free transmission scheme based on multiple pilots is proposed so that the pilot collision probability can be significantly reduced. That is, when service data arrives and needs to be transmitted, the transmitter sends multiple pilots simultaneously for one data transmission. Each pilot has a corresponding pilot sequence. Moreover, during the data transmission, the to-be-sent data symbol needs to be spread using the spreading sequence. In this manner, for the contention-based grant-free transmission based on multiple pilots, N pilot sequences and one spreading sequence need to be acquired, where N is an integer greater than 1. In the following embodiments of the present application, unless otherwise specified, N=2 is used as an example for the schematic description, that is, the contention-based grant-free transmission based on two pilots is used as an example for the schematic description, but the data transmission method provided in the embodiments of the present application is not limited to two pilots. At least one pilot sequence among the N pilot sequences has an association relationship with the spreading sequence, and multiple association relationships may exist between the at least one pilot sequence and the spreading sequence. The association relationship between the at least one pilot sequence and the spreading sequence is described in detail below using multiple embodiments. In addition, the association relationship between the at least one pilot sequence and the spreading sequence may also be referred to as a corresponding relationship between the at least one pilot sequence and the spreading sequence or a mapping relationship between the at least one pilot sequence and the spreading sequence.

The N pilot sequences are from at least one pilot sequence set, that is, the N pilot sequences may be from the same pilot sequence set, the N pilot sequences may be from different pilot sequence sets, or the N pilot sequences may be randomly selected from multiple pilot sequence sets. The spreading sequence is from a spreading sequence set. For example, the size of the spreading sequence set is M, and M=16, that is, the spreading sequence set includes 16 spreading sequences; and the size of the pilot sequence set is K×M, where M denotes the number of pilot sequence subsets, that is, the pilot sequence set may be divided into M pilot sequence subsets, and K denotes the number of pilot sequences in each pilot sequence subset. For example, K=9, then each pilot sequence subset includes nine pilot sequences, and the 16 pilot sequence subsets include a total of 144 pilot sequences. The preceding K, M, and N may be set to different values according to actual usage requirements. The pilot sequence set may not be divided into pilot sequence subsets.

In S120, to-be-sent data is processed by using the spreading sequence to generate a to-be-sent data symbol.

After the N pilot sequences and the spreading sequence are acquired, the to-be-sent data is processed using the spreading sequence to generate the to-be-sent data symbol. Processing the to-be-sent data using the spreading sequence to generate the to-be-sent data symbol may be spreading, modulating, or mapping the to-be-sent data using the spreading sequence to generate the to-be-sent data symbol.

In S130, the N pilot sequences and the to-be-sent data symbol are sent.

After the to-be-sent data symbol is obtained, the N pilot sequences acquired in S110 and the to-be-sent data symbol generated in S120 may be sent. The transmitter may generate a signal according to the N pilot sequences and the to-be-sent data symbol and send the signal; alternatively, the transmitter may generate and send a signal corresponding to N pilots according to the N pilot sequences, and generate and send a signal according to the to-be-sent data symbol. In this manner, the receiver may receive N pilots and the data symbol, at least one pilot among the N pilots is detected to identify at least one pilot sequence sent by the transmitter, and the spreading sequence used by the transmitter is determined according to the identified pilot sequence. The received data symbol is detected using the spreading sequence, thereby completing data reception.

In the embodiment of the present application, the transmitter sends data in a contention-based grant-free manner; the receiver does not know which users send data or perform accessing this time, nor does the receiver know the identity information of these users; and the transmitter may carry user identity information in the to-be-sent data. After successfully decoding a user, the receiver may acquire the identity of the transmitter through the user identity information carried in the data. To improve the multi-user detection performance, the receiver may use interference cancellation technology to reconstruct the N pilots and data symbols of successfully decoded users and cancel the N pilots and data symbols from the received N pilots and data symbols, thereby improving the detection performance for other users. To facilitate the reconstruction and interference cancellation by the receiver, the transmitter needs to carry the information about the N pilots in the to-be-sent data. In an embodiment, the transmitter may randomly select a spreading sequence from the spreading sequence set or indicate a spreading sequence in the spreading sequence set according to the designated data in the data. Therefore, the to-be-sent data may include at least one of the following pieces of information: user identity information, service data, information about the N pilots corresponding to the N pilot sequences, and information about the spreading sequence. That is, the data transmission method provided in the embodiment of the present application may be used for the preceding to-be-sent data, and the manner of associating multiple pilot sequences with one spreading sequence is adopted, thereby reducing the pilot collision probability during contention-based grant-free transmission and improving the system performance. The information about a pilot may be a pilot sequence index.

In the data transmission method provided in this embodiment, N pilot sequences and one spreading sequence are acquired, where at least one pilot sequence among the N pilot sequences has an association relationship with the spreading sequence; and after the to-be-sent data is processed by using the spreading sequence to generate the to-be-sent data symbol, the N pilot sequences and the to-be-sent data symbol are sent, thereby achieving the association between the spreading sequence and multiple pilots and improving the performance of contention-based grant-free transmission.

In an embodiment, N pilot sequences correspond to N pilots, that is, each pilot sequence corresponds to one pilot. In other words, if N pilots exist and each pilot has a corresponding pilot sequence, the N pilots have N corresponding pilot sequences; or each pilot may be represented by a pilot sequence, and the N pilot sequences are pilot sequences corresponding to the N pilots. In some cases, the pilot and the pilot sequence in this embodiment may be considered equivalent.

In an embodiment, acquiring the N pilot sequences and the spreading sequence includes acquiring the spreading sequence and acquiring the N pilot sequences according to the spreading sequence.

In an example, the spreading sequence is acquired and the N pilot sequences are acquired from a pilot sequence subset associated with the spreading sequence. The pilot sequence set includes at least one pilot sequence subset, and the pilot sequence subset includes at least one pilot sequence. One spreading sequence may be acquired, the spreading sequence has an association relationship with a pilot sequence subset, and then N pilot sequences may be acquired from the pilot sequence subset associated with the spreading sequence. The N pilot sequences may be the same, or the N pilot sequences may be completely different, or T pilot sequences among the N pilot sequences may be the same, where T is greater than or equal to 2 and less than N.

In an example, the spreading sequence is acquired and the N pilot sequences are acquired from a pilot sequence subset group associated with the spreading sequence. The pilot sequence subsets in the pilot sequence set are further grouped into multiple pilot sequence subset groups, each pilot sequence subset group includes at least one pilot sequence subset, and each pilot sequence subset includes at least one pilot sequence. The pilot sequence subsets in each pilot sequence subset group may belong to one pilot sequence set or different pilot sequence sets. One spreading sequence may be acquired first, the spreading sequence has an association relationship with a pilot sequence subset group, and then N pilot sequences may be acquired from the pilot sequence subset group associated with the spreading sequence.

In an example, the spreading sequence is acquired, at least one pilot sequence is acquired from a first pilot sequence subset group associated with the spreading sequence, and the other at most N−1 pilot sequences are acquired from a second pilot sequence subset group associated with the first pilot sequence subset group. The first pilot sequence subset group includes at least one pilot sequence subset, and the second pilot sequence subset group includes at least one pilot sequence subset. One spreading sequence may be acquired first, the spreading sequence has an association relationship with the first pilot sequence subset group, and then at least one pilot sequence may be acquired from the first pilot sequence subset group associated with the spreading sequence. An association relationship exists between the first pilot sequence subset group and the second pilot sequence subset group, and the other at most N−1 pilot sequences are acquired from the second pilot sequence subset group associated with the first pilot sequence subset group. The first pilot sequence subset group and the second pilot sequence subset group may belong to the same pilot sequence set or different pilot sequence sets.

In an embodiment, acquiring the N pilot sequences and the spreading sequence includes acquiring at least one pilot sequence subset and acquiring the spreading sequence and the N pilot sequences according to the at least one pilot sequence subset.

In an example, a pilot sequence subset is acquired, the spreading sequence associated with the pilot sequence subset is acquired, and the N pilot sequences are acquired from the pilot sequence subset. First, the pilot sequence subset is acquired from the pilot sequence set. An association relationship exists between the spreading sequence and the pilot sequence subset. According to the association relationship between the spreading sequence and the pilot sequence subset, the spreading sequence corresponding to the pilot sequence subset is determined, and the N pilot sequences are acquired from the pilot sequence subset.

In an example, a pilot sequence subset group is acquired, the spreading sequence associated with the pilot sequence subset group is acquired, and the N pilot sequences are acquired from the pilot sequence subset group. The pilot sequence subsets in the pilot sequence set are further grouped into multiple pilot sequence subset groups, each pilot sequence subset group includes at least one pilot sequence subset, and each pilot sequence subset includes at least one pilot sequence. A pilot sequence subset group may be acquired first. An association relationship exists between the spreading sequence and the pilot sequence subset group. The spreading sequence is determined according to the association relationship between the spreading sequence and the pilot sequence subset group, and the N pilot sequences are acquired from the pilot sequence subset group. The pilot sequence subsets in each pilot sequence subset group may belong to the same pilot sequence set or different pilot sequence sets.

In an example, a first pilot sequence subset group is acquired, the spreading sequence associated with the first pilot sequence subset group is acquired, at least one pilot sequence is acquired from the first pilot sequence subset group, and the other at most N−1 pilot sequences are acquired from a second pilot sequence subset group associated with the first pilot sequence subset group. The first pilot sequence subset group includes at least one pilot sequence subset, and the second pilot sequence subset group includes at least one pilot sequence subset. The first pilot sequence subset group may be acquired, and then at least one pilot sequence may be acquired from the first pilot sequence subset group. An association relationship exists between the spreading sequence and the first pilot sequence subset group. The spreading sequence is determined according to the association relationship between the spreading sequence and the first pilot sequence subset group. An association relationship exists between the first pilot sequence subset group and the second pilot sequence subset group. The other at most N−1 pilot sequences are acquired from the second pilot sequence subset group associated with the first pilot sequence subset group. The first pilot sequence subset group and the second pilot sequence subset group may belong to the same pilot sequence set or different pilot sequence sets.

In an embodiment, acquiring the N pilot sequences and the spreading sequence includes acquiring at least one pilot sequence and acquiring the spreading sequence and the other at most N−1 pilot sequences according to the at least one pilot sequence.

In an example, a first pilot sequence is acquired, a pilot sequence subset to which the first pilot sequence belongs is determined, the spreading sequence associated with the pilot sequence subset is acquired, and the other N−1 pilot sequences are acquired from the pilot sequence subset. The first pilot sequence is acquired from the pilot sequence set, and then the pilot sequence subset to which the first pilot sequence belongs is determined. An association relationship exists between the spreading sequence and the pilot sequence subset. The spreading sequence is determined according to the association relationship between the spreading sequence and the pilot sequence subset, and the other N−1 pilot sequences are acquired from the pilot sequence subset.

In an example, a first pilot sequence is acquired, a pilot sequence subset group to which the first pilot sequence belongs is determined, the spreading sequence associated with the pilot sequence subset group is acquired, and the other N−1 pilot sequences are acquired from the pilot sequence subset group. The pilot sequence subsets in the pilot sequence set are further grouped into multiple pilot sequence subset groups, each pilot sequence subset group includes at least one pilot sequence subset, and each pilot sequence subset includes at least one pilot sequence. The first pilot sequence is acquired from the pilot sequence set, a pilot sequence subset to which the first pilot sequence belongs is determined, and then the pilot sequence subset group to which the first pilot sequence belongs is determined. An association relationship exists between the spreading sequence and the pilot sequence subset group. The spreading sequence is determined according to the association relationship between the spreading sequence and the pilot sequence subset group, and the other N−1 pilot sequences are acquired from the pilot sequence subset group. The pilot sequence subsets in the pilot sequence subset group may belong to the same pilot sequence set or different pilot sequence sets.

In an example, a first pilot sequence is acquired, a first pilot sequence subset group to which the first pilot sequence belongs is determined, the spreading sequence associated with the first pilot sequence subset group is acquired, and the other N−1 pilot sequences are acquired from a second pilot sequence subset group associated with the first pilot sequence subset group. The first pilot sequence subset group includes one pilot sequence subset, and the second pilot sequence subset group includes at least one pilot sequence subset. The first pilot sequence is acquired from the pilot sequence set, and then the first pilot sequence subset group to which the first pilot sequence belongs is determined. An association relationship exists between the spreading sequence and the first pilot sequence subset group. The spreading sequence is determined according to the association relationship between the spreading sequence and the first pilot sequence subset group. An association relationship exists between the first pilot sequence subset group and the second pilot sequence subset group. The other N−1 pilot sequences are acquired from the second pilot sequence subset group associated with the first pilot sequence subset group. The first pilot sequence subset group and the second pilot sequence subset group may belong to the same pilot sequence set or different pilot sequence sets.

In an example, a first pilot sequence is acquired, the spreading sequence is acquired according to the first pilot sequence, and the other N−1 pilot sequences are acquired according to the first pilot sequence or the spreading sequence. The pilot sequence set is not divided into pilot sequence subsets. First, the first pilot sequence is acquired from the pilot sequence set. An association relationship exists between the first pilot sequence and the spreading sequence. The spreading sequence is determined according to the association relationship between the first pilot sequence and the spreading sequence. Then, the other N−1 pilot sequences are acquired from the pilot sequence set. The other N−1 pilot sequences may be selected according to certain rules; or the selection range of the other N−1 pilot sequences may be determined according to the first pilot sequence, and then the other N−1 pilot sequences may be selected within the determined selection range; or the selection range of the other N−1 pilot sequences may be determined according to the spreading sequence, and then the other N−1 pilot sequences may be selected within the determined selection range. The first pilot sequence and the other N−1 pilot sequences may belong to the same pilot sequence set or different pilot sequence sets.

In this embodiment, acquiring the first pilot sequence not only means acquiring one pilot sequence but also means acquiring at least one pilot sequence. The at least one pilot sequence may be selected within a certain pilot sequence range. An association relationship exists between the at least one pilot sequence and the spreading sequence. Then, the other at most N−1 pilot sequences are acquired. The other at most N−1 pilot sequences may be selected according to certain rules; or the selection range of the other at most N−1 pilot sequences may be determined according to the at least one pilot sequence, and then the other at most N−1 pilot sequences may be selected within the determined selection range of the pilot sequences; or the selection range of the other at most N−1 pilot sequences may be determined according to the spreading sequence, and then the other at most N−1 pilot sequences may be selected within the determined selection range of the pilot sequences.

The preceding data transmission method is further described below with reference to several specific embodiments.

### First Embodiment

In the data transmission method provided in this embodiment, the transmitter randomly selects a spreading sequence from the spreading sequence set, determines the pilot sequence subset (group) corresponding to the spreading sequence according to the association relationship between the spreading sequence and the pilot sequence subset (group), and then randomly selects pilot sequences from the pilot sequence subset (group).

First, the transmitter randomly selects a spreading sequence (spreading sequence 1) from the spreading sequence set.

In this embodiment, the spreading sequences are in one-to-one correspondence with the pilot sequence subsets.

According to the one-to-one correspondence between the spreading sequences and the pilot sequence subsets, the transmitter randomly selects a pilot sequence (pilot sequence 2) from pilot sequence subset 1 of the pilot sequence set as pilot 1.

In this embodiment, the pilot sequence subsets to which the pilot sequences of pilot 1 and pilot 2 belong are from the same pilot sequence set and are associated with each other.

The transmitter randomly selects a pilot sequence (pilot sequence 2K) from a pilot sequence subset (pilot sequence subset 2) associated with pilot sequence subset 1 as pilot 2.

In an example, an association relationship between the pilot sequence subsets may be expressed below.

$$y = mod ( x + z - 1 , M ) + 1 , 0 \leq z \leq M - 1 \qquad ( 1 )$$

mod denotes the modulo operation; x and y denote the pilot sequence subsets to which the pilot sequences of pilot 1 and pilot 2 belong, respectively; and z denotes the interval or offset between the two pilot sequence subsets. The value of z is known to the transmitter and the receiver. For example, the receiver notifies the transmitter of the value of z via broadcasting.

According to formula (1), the pilot sequence subset to which the pilot sequence of one pilot belongs may be used to infer the pilot sequence subset to which the pilot sequence of the other pilot belongs.

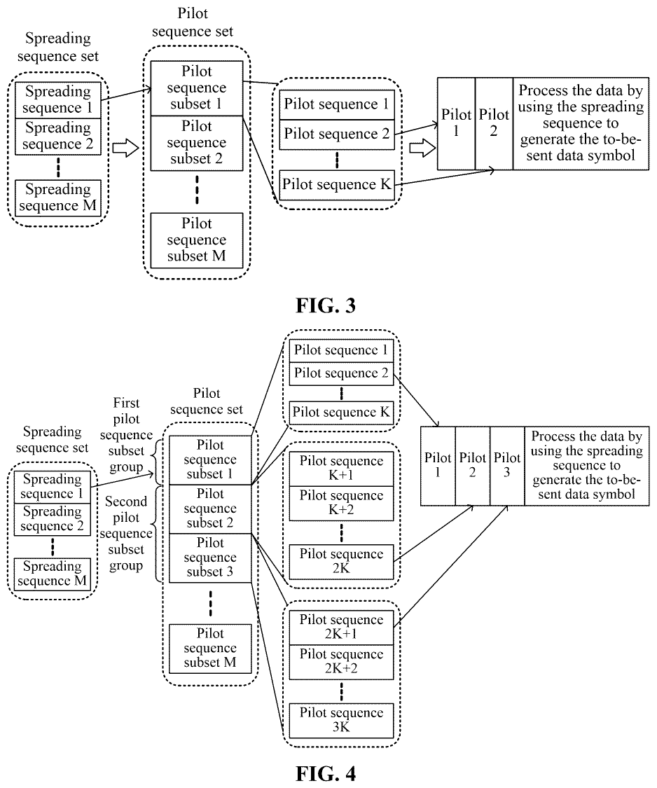

FIG. 2 is schematic diagram one illustrating the association relationship between pilot sequences and spreading sequences according to first embodiment of the present application. According to formula (1), in FIG. 2, x=1, z=1, and y=2. FIG. 2 may be considered as that the transmitter randomly selects pilot sequences from two different pilot sequence subsets of the pilot sequence set as pilot 1 and pilot 2, respectively, or the pilot sequences of the two pilots are from different pilot sequence subsets of the pilot sequence set.

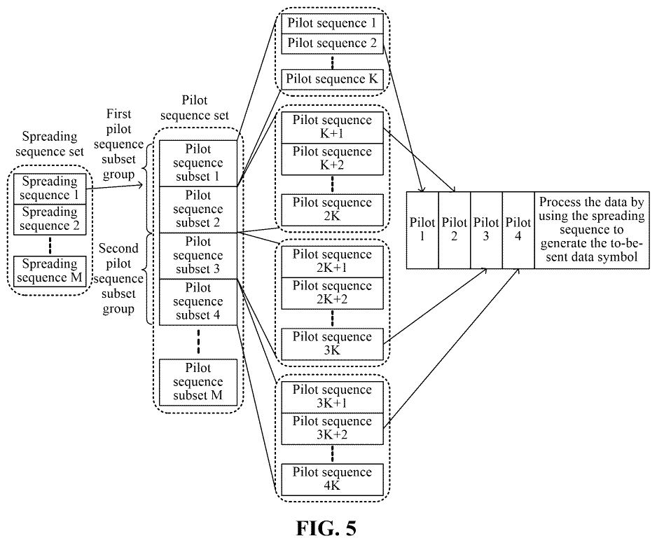

FIG. 3 is schematic diagram two illustrating the association relationship between pilot sequences and spreading sequences according to first embodiment of the present application. FIG. 3 may be considered as the case where z=0 in formula (1), that is, the transmitter randomly selects two pilot sequences from the same pilot sequence subset of the pilot sequence set as pilot 1 and pilot 2, respectively; or the pilot sequences of the two pilots are from the same pilot sequence subset of the pilot sequence set, or no interval or offset parameter z exists.

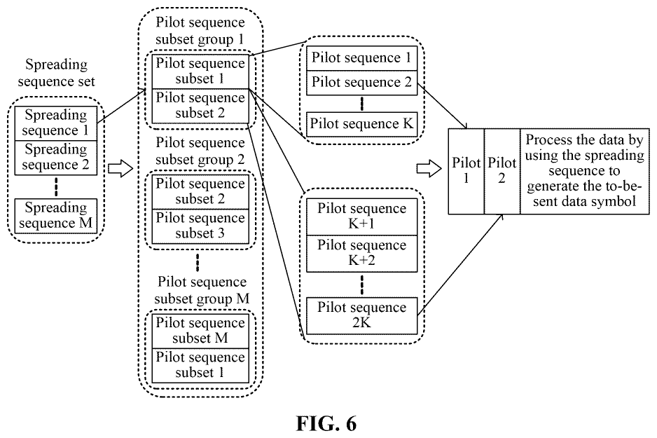

FIG. 4 is schematic diagram three illustrating the association relationship between pilot sequences and spreading sequences according to first embodiment of the present application. The case where N=3, that is, the transmitter sends three pilots, is used as an example. The transmitter randomly selects a spreading sequence from the spreading sequence set. An association relationship exists between the spreading sequence and the first pilot sequence subset group. The transmitter determines the first pilot sequence subset group corresponding to the spreading sequence, selects one pilot sequence from the first pilot sequence subset group as pilot 1, and selects two pilot sequences from the second pilot sequence subset group associated with the first pilot sequence subset group as pilot 2 and pilot 3.

First, the transmitter randomly selects a spreading sequence (spreading sequence 1) from the spreading sequence set.

In this embodiment, the spreading sequence is in one-to-one correspondence with the first pilot sequence subset group. The first pilot sequence subset group includes one pilot sequence subset.

According to the one-to-one correspondence between the spreading sequence and the first pilot sequence subset group, the transmitter randomly selects a pilot sequence (pilot sequence 2) from the first pilot sequence subset group (pilot sequence subset 1) as pilot 1.

In this embodiment, the first pilot sequence subset group and the second pilot sequence subset group belong to the same pilot sequence set and are associated with each other. The second pilot sequence subset group includes two pilot sequence subsets.

The transmitter randomly selects a pilot sequence (pilot sequence 2K and pilot sequence 2K+1) from each pilot sequence subset (pilot sequence subset 2 and pilot sequence subset 3) of the second pilot sequence subset group associated with the first pilot sequence subset group as pilot 2 and pilot 3, respectively.

In an example, the association relationship between the first pilot sequence subset group and the second pilot sequence subset group may be expressed by formula (1). Specifically, the association relationship between the first pilot sequence subset in the first pilot sequence subset group and the first pilot sequence subset in the second pilot sequence subset group may be expressed by formula (1). Alternatively, the association relationship between a pilot sequence subset in the first pilot sequence subset group and a pilot sequence subset in the second pilot sequence subset group may be expressed by formula (1).

FIG. 5 is schematic diagram four illustrating the association relationship between pilot sequences and spreading sequences according to first embodiment of the present application. The case where N=4, that is, the transmitter sends four pilots, is used as an example. The transmitter randomly selects a spreading sequence from the spreading sequence set. An association relationship exists between the spreading sequence and the first pilot sequence subset group. The transmitter determines the first pilot sequence subset group corresponding to the spreading sequence, selects two pilot sequences from the first pilot sequence subset group as pilot 1 and pilot 2, and selects two pilot sequences from the second pilot sequence subset group associated with the first pilot sequence subset group as pilot 3 and pilot 4.

First, the transmitter randomly selects a spreading sequence (spreading sequence 1) from the spreading sequence set.

In this embodiment, the spreading sequence is in one-to-one correspondence with the first pilot sequence subset group. The first pilot sequence subset group includes two pilot sequence subsets.

According to the one-to-one correspondence between the spreading sequence and the first pilot sequence subset group, the transmitter randomly selects a pilot sequence (pilot sequence 2 and pilot sequence K+1) from each pilot sequence subset (pilot sequence subset 1 and pilot sequence subset 2) of the first pilot sequence subset group as pilot 1 and pilot 2, respectively.

In this embodiment, the first pilot sequence subset group and the second pilot sequence subset group belong to the same pilot sequence set and are associated with each other. The second pilot sequence subset group includes two pilot sequence subsets.

The transmitter randomly selects pilot sequences (pilot sequence 3K and pilot sequence 3K+2) from the pilot sequence subsets (pilot sequence subset 3 and pilot sequence subset 4) of the second pilot sequence subset group associated with the first pilot sequence subset group as pilot 3 and pilot 4, respectively.

In an example, the association relationship between the first pilot sequence subset group and the second pilot sequence subset group may be expressed by formula (1). Specifically, the association relationship between the first pilot sequence subset in the first pilot sequence subset group and the first pilot sequence subset in the second pilot sequence subset group may be expressed by formula (1). Alternatively, the association relationship between a pilot sequence subset in the first pilot sequence subset group and a pilot sequence subset in the second pilot sequence subset group may be expressed by formula (1).

In the example where N=2 shown in FIG. 2, it may be considered as that the first pilot sequence subset group and the second pilot sequence subset group each include only one pilot sequence subset. In the example where N=3 shown in FIG. 4, the first pilot sequence subset group includes one pilot sequence subset, and the second pilot sequence subset group includes two pilot sequence subsets. In the example where N=4 shown in FIG. 5, the first pilot sequence subset group includes two pilot sequence subsets, and the second pilot sequence subset group includes two pilot sequence subsets.

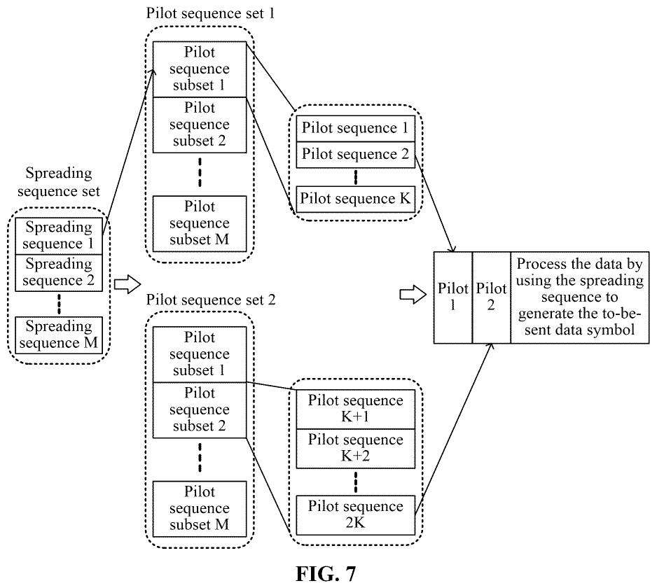

FIG. 6 is schematic diagram five illustrating the association relationship between pilot sequences and spreading sequences according to first embodiment of the present application. As shown in FIG. 6, M pilot sequence subsets of the pilot sequence set are grouped into M pilot sequence subset groups. Each pilot sequence subset group includes two pilot sequence subsets. In FIG. 6, each pilot sequence subset group includes two different pilot sequence subsets, and the interval or offset z between the two different pilot sequence subsets is 1, which corresponds to FIG. 2. If each pilot sequence subset group in FIG. 6 includes two identical pilot sequence subsets, that is, the interval or offset z of the pilot sequence subsets is 0 (no interval or offset parameter z exists), which corresponds to FIG. 3.

First, the transmitter randomly selects a spreading sequence (spreading sequence 1) from the spreading sequence set.

In this embodiment, the spreading sequences are in one-to-one correspondence with the pilot sequence subset groups.

According to the one-to-one correspondence between the spreading sequences and the pilot sequence subset groups, the transmitter randomly selects pilot sequences (pilot sequence 2 and pilot sequence 2K) from the pilot sequence subsets in pilot sequence subset group 1 as pilot 1 and pilot 2, respectively.

In this embodiment, the pilot sequence subsets in the pilot sequence subset group are from the same pilot sequence set.

In an example, the transmitter may randomly select a spreading sequence from the spreading sequence set or indicate a spreading sequence in the spreading sequence set according to the designated data in the data.

In an example, the N pilot sequences randomly selected by the transmitter from the same pilot sequence subset may be the same or different (as shown in FIG. 3).

In an example, the transmitter may include the information about N pilots in the to-be-sent data. When the receiver correctly decodes the data from the transmitter, through the data, the receiver may know the N pilots sent by the transmitter. The N pilots and the data symbol of the transmitter are reconstructed and interference cancellation is performed so that the detection performance for other transmitters can be improved.

The information about a pilot may be a pilot sequence index.

In an example, the data may further include at least one of the following: user identity information, service data, the information about the N pilots corresponding to the N pilot sequences, or the information about the spreading sequence.

In an example, the data is processed using the spreading sequence to generate the to-be-sent data symbol.

In an example, the to-be-sent data is spread, modulated, or mapped using the spreading sequence to generate the to-be-sent data symbol.

Finally, the transmitter sends the N pilot sequences and the generated to-be-sent data symbol.

In an example, the transmitter may generate a signal according to the N pilot sequences and the to-be-sent data symbol and send the signal; or the transmitter may generate and send a signal corresponding to N pilots according to the N pilot sequences and generate and send a signal according to the to-be-sent data symbol. In an example, the N pilots may be frequency-division multiplexed, time-division multiplexed, or code-division multiplexed on the pilot resources.

In an example, the pilot may be a preamble or a demodulation reference signal (DMRS).

In an example, the pilot sequence may be a Zadoff-Chu (ZC) sequence, a Hadamard sequence, a Walsh sequence, or a Walsh-Hadamard sequence; or the sequence element is from the set {1, i, −1, −i}. The Hadamard sequence and the Walsh sequence may each be formed by 1 and −1, and the sequence composition is simple. In addition to being suitable for the grant-free transmission in the present application, the Hadamard sequence and the Walsh sequence may further be used for low-power and low-cost terminals, such as passive Internet of Things (IoT).

The following embodiments only describe the differences from the preceding embodiment, and the same aspects, such as the steps after the N pilot sequences and the spreading sequence are acquired, are not repeated.

### Second Embodiment

In the first embodiment, the pilot sequences of the N pilots are from the same pilot sequence set, or the pilot sequence subsets to which the pilot sequences of the N pilots belong are from the same pilot sequence set. In this embodiment, the pilot sequences of the N pilots are from different pilot sequence sets, or the pilot sequence subsets to which the pilot sequences of the N pilots belong are from different pilot sequence sets.

FIG. 7 is schematic diagram one illustrating the association relationship between pilot sequences and spreading sequences according to second embodiment of the present application. First, the transmitter randomly selects a spreading sequence (spreading sequence 1) from the spreading sequence set.

In this embodiment, the spreading sequences are in one-to-one correspondence with the pilot sequence subsets.

According to the one-to-one correspondence between the spreading sequences and the pilot sequence subsets, the transmitter randomly selects a pilot sequence (pilot sequence 2) from pilot sequence subset 1 of pilot sequence set 1 as pilot 1.

In this embodiment, the pilot sequence subsets to which the pilot sequences of pilot 1 and pilot 2 belong are from different pilot sequence sets and are associated with each other.

The transmitter randomly selects a pilot sequence (pilot sequence 2K) from a pilot sequence subset (pilot sequence subset 2) in pilot sequence set 2 associated with pilot sequence subset 1 in pilot sequence set 1 as pilot 2.

In an example, an association relationship between pilot sequence subsets of different pilot sequence sets may be expressed below.

$$y 2 = mod ( x 1 + z - 1 , M ) + 1 , 0 \leq z \leq M - 1 \qquad ( 2 )$$

mod denotes the modulo operation; x1 denotes the pilot sequence subset in pilot sequence set 1 to which the pilot sequence of pilot 1 belongs, and y2 denotes the pilot sequence subset in pilot sequence set 2 to which the pilot sequence of pilot 2 belongs; and z denotes the interval or offset between the two pilot sequence subsets. According to formula (2), the pilot sequence subset in the pilot sequence set to which the pilot sequence of one pilot belongs may be used to infer the pilot sequence subset in the pilot sequence set to which the pilot sequence of the other pilot belongs. The value of z is known to the transmitter and the receiver. For example, the receiver notifies the transmitter of the value of z via broadcasting.

According to formula (2), in FIGS. 7, x1=1, z=1, and y2=2. FIG. 7 may be considered as that the transmitter randomly selects pilot sequences from different pilot sequence subsets of different pilot sequence sets as pilot 1 and pilot 2, respectively, or the pilot sequences of the two pilots are from different pilot sequence subsets of different pilot sequence sets.

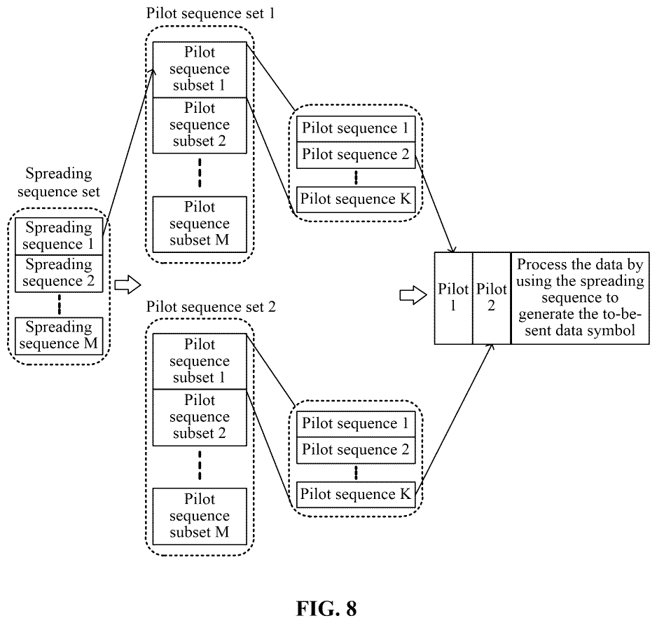

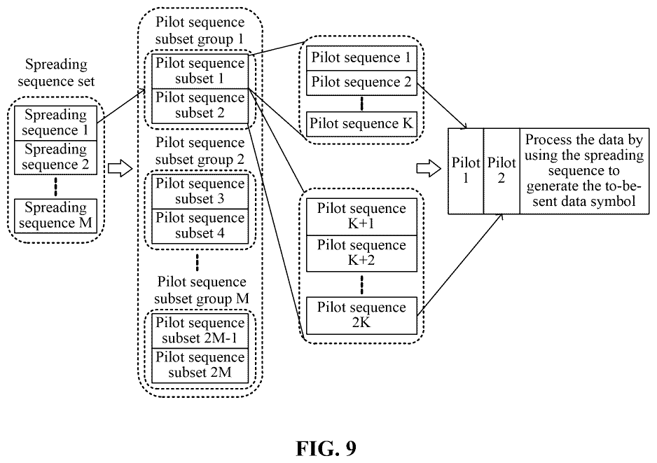

FIG. 8 is schematic diagram two illustrating the association relationship between pilot sequences and spreading sequences according to second embodiment of the present application. FIG. 8 may be considered as the case where z=0 in formula (2), that is, the transmitter randomly selects pilot sequences from the pilot sequence subsets with the same index in different pilot sequence sets as pilot 1 and pilot 2, respectively, or the pilot sequences of the two pilots are from the pilot sequence subsets with the same index in different pilot sequence sets. In other words, in FIG. 7, the transmitter randomly selects pilot sequences from the pilot sequence subsets with different indices in different pilot sequence sets; and in FIG. 8, the transmitter randomly selects pilot sequences from the pilot sequence subsets with the same index in different pilot sequence sets.

In an example, the number K of pilot sequences included in the pilot sequence subset in pilot sequence set 1 and the number K of pilot sequences included in the pilot sequence subset in pilot sequence set 2 may be the same or different. In other words, the number K×M of pilot sequences included in pilot sequence set 1 and the number K×M of pilot sequences included in pilot sequence set 2 may be the same or different.

In addition, the association relationship between the spreading sequence and the first pilot sequence subset group may also be established in second embodiment. The first pilot sequence subset group and the second pilot sequence subset group each include at least one pilot sequence subset. The first pilot sequence subset group and the second pilot sequence subset group belong to different pilot sequence sets and are associated with each other. In an example, the association relationship between the first pilot sequence subset group and the second pilot sequence subset group may be expressed by formula (2). Specifically, the association relationship between the first pilot sequence subset in the first pilot sequence subset group and the first pilot sequence subset in the second pilot sequence subset group may be expressed by formula (2). Alternatively, the association relationship between a pilot sequence subset in the first pilot sequence subset group and a pilot sequence subset in the second pilot sequence subset group may be expressed by formula (2). First, the transmitter randomly selects a spreading sequence from the spreading sequence set. According to the association relationship between the spreading sequence and the first pilot sequence subset group, the first pilot sequence subset group in pilot sequence set 1 is determined, and at least one pilot sequence is selected from the first pilot sequence subset group. According to the association relationship between the first pilot sequence subset group and the second pilot sequence subset group, the second pilot sequence subset group in pilot sequence set 2 is determined and at most N−1 pilot sequences are selected from the second pilot sequence subset group.

FIG. 9 is schematic diagram three illustrating the association relationship between pilot sequences and spreading sequences according to second embodiment of the present application. 2M pilot sequence subsets of two different pilot sequence sets are grouped into M pilot sequence subset groups. Each pilot sequence subset group includes two pilot sequence subsets, and the two pilot sequence subsets belong to different pilot sequence sets. In an example, M odd-indexed pilot sequence subsets 1, 3, . . . , and 2M−1 belong to one pilot sequence set, and M even-indexed pilot sequence subsets 2, 4, . . . , and 2M belong to the other pilot sequence set. If the two pilot sequence subsets included in each pilot sequence subset group in FIG. 9 are from different pilot sequence sets and have different indices, this case corresponds to FIG. 7. If the two pilot sequence subsets included in each pilot sequence subset group in FIG. 9 are from different pilot sequence sets and have the same index, the case corresponds to FIG. 8.

First, the transmitter randomly selects a spreading sequence (spreading sequence 1) from the spreading sequence set.

In this embodiment, the spreading sequences are in one-to-one correspondence with the pilot sequence subset groups.

According to the one-to-one correspondence between the spreading sequences and the pilot sequence subset groups, the transmitter randomly selects a pilot sequence (pilot sequence 2 and pilot sequence 2K) from each pilot sequence subset in pilot sequence subset group 1 as pilot 1 and pilot 2, respectively.

### Third Embodiment

In first embodiment and second embodiment, the transmitter selects the spreading sequence, determines the pilot sequence subset (group) according to the association relationship between the spreading sequence and the pilot sequence subset (group), and selects the pilot sequences from the pilot sequence subset (group). In this embodiment, the transmitter selects the pilot sequence subset (group), then determines the spreading sequence, and selects the pilot sequences.

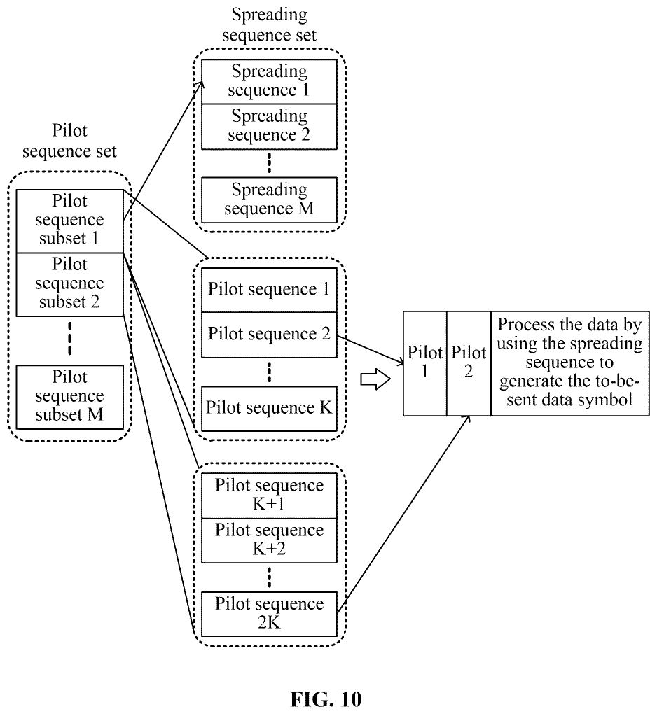

FIG. 10 is schematic diagram one illustrating the association relationship between pilot sequences and spreading sequences according to third embodiment of the present application. First, the transmitter randomly selects a pilot sequence subset (pilot sequence subset 1) from the pilot sequence set and randomly selects a pilot sequence (pilot sequence 2) from pilot sequence subset 1 as pilot 1.

In this embodiment, the pilot sequence subsets are in one-to-one correspondence with the spreading sequences.

According to the one-to-one correspondence between the pilot sequence subsets and the spreading sequences, the transmitter selects spreading sequence 1 in the spreading sequence set as the spreading sequence.

In this embodiment, the pilot sequence subsets to which the pilot sequences of pilot 1 and pilot 2 belong are from the same pilot sequence set and are associated with each other.

In an example, an association relationship between the pilot sequence subsets may be expressed by formula (1). The transmitter randomly selects a pilot sequence (pilot sequence 2K) from a pilot sequence subset (pilot sequence subset 2) associated with pilot sequence subset 1 as pilot 2.

FIG. 10 may be considered as that the transmitter randomly selects pilot sequences from two different pilot sequence subsets of the pilot sequence set as pilot 1 and pilot 2, respectively, or the pilot sequences of the two pilots are from different pilot sequence subsets of the pilot sequence set.

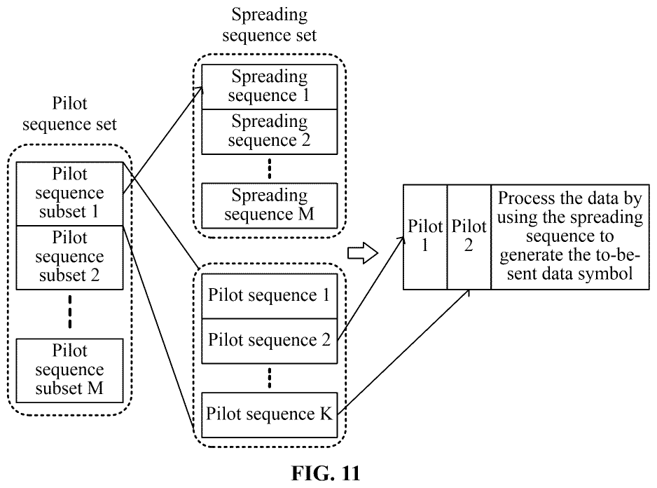

FIG. 11 is schematic diagram two illustrating the association relationship between pilot sequences and spreading sequences according to third embodiment of the present application. FIG. 11 may be considered as the case where z=0 in formula (1), that is, the transmitter randomly selects two pilot sequences from the same pilot sequence subset of the pilot sequence set as pilot 1 and pilot 2, respectively, or the pilot sequences of the two pilots are from the same pilot sequence subset of the pilot sequence set.

In an example, the transmitter may randomly select a pilot sequence subset from the pilot sequence set or indicate a pilot sequence subset in the pilot sequence set according to the designated data in the data.

In an example, the N pilot sequences randomly selected by the transmitter from the same pilot sequence subset may be the same or different (as shown in FIG. 11).

In addition, the association relationship between the spreading sequence and the first pilot sequence subset group may also be established in the third embodiment. The first pilot sequence subset group and the second pilot sequence subset group each include at least one pilot sequence subset. The first pilot sequence subset group and the second pilot sequence subset group belong to the same pilot sequence set and are associated with each other. In an example, the association relationship between the first pilot sequence subset group and the second pilot sequence subset group may be expressed by formula (1). Specifically, the association relationship between the first pilot sequence subset in the first pilot sequence subset group and the first pilot sequence subset in the second pilot sequence subset group may be expressed by formula (1). Alternatively, the association relationship between a pilot sequence subset in the first pilot sequence subset group and a pilot sequence subset in the second pilot sequence subset group may be expressed by formula (1). First, the transmitter selects the first pilot sequence subset group from the pilot sequence set and randomly selects at least one pilot sequence from the first pilot sequence subset group. The spreading sequence is determined according to the association relationship between the spreading sequence and the first pilot sequence subset group. According to the association relationship between the first pilot sequence subset group and the second pilot sequence subset group, the second pilot sequence subset group is determined and at most N−1 pilot sequences are selected from the second pilot sequence subset group.

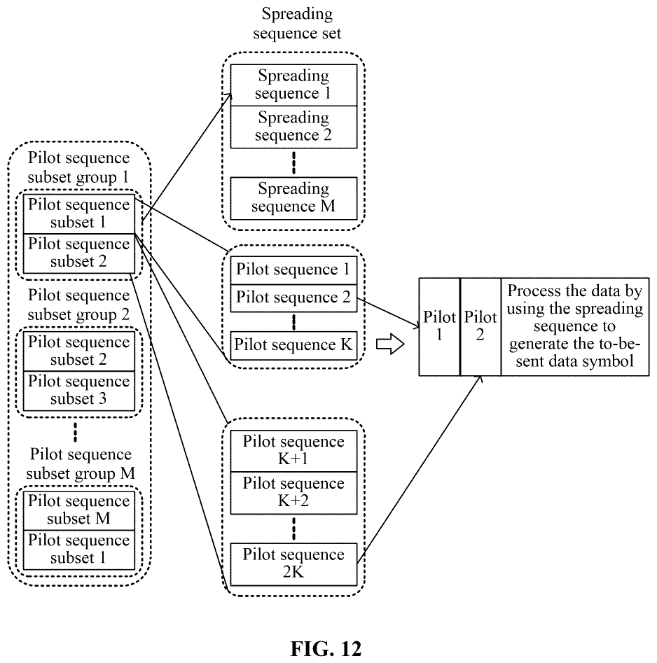

FIG. 12 is schematic diagram three illustrating the association relationship between pilot sequences and spreading sequences according to third embodiment of the present application. As shown in FIG. 12, each pilot sequence subset group includes two pilot sequence subsets. In FIG. 12, each pilot sequence subset group includes two different pilot sequence subsets, and the interval or offset z between the two different pilot sequence subsets is 1, which corresponds to FIG. 10. If each pilot sequence subset group in FIG. 12 includes two identical pilot sequence subsets, that is, the interval or offset z of the pilot sequence subsets is 0 (no interval or offset parameter z exists), which corresponds to FIG. 11.

First, the transmitter randomly selects a pilot sequence subset group (pilot sequence subset group 1) and randomly selects a pilot sequence (pilot sequence 2 and pilot sequence 2K) from each pilot sequence subset in pilot sequence subset group 1 as pilot 1 and pilot 2, respectively.

In this embodiment, the pilot sequence subset groups are in one-to-one correspondence with the spreading sequences. According to the one-to-one correspondence between the pilot sequence subset groups and the spreading sequences, the transmitter selects spreading sequence 1 as the spreading sequence.

In this embodiment, the pilot sequence subsets in the pilot sequence subset group are from the same pilot sequence set.

### Fourth Embodiment

In third embodiment, the transmitter selects the pilot sequence subsets (groups) from the same pilot sequence set. In this embodiment, the transmitter selects the pilot sequence subsets (groups) from different pilot sequence sets.

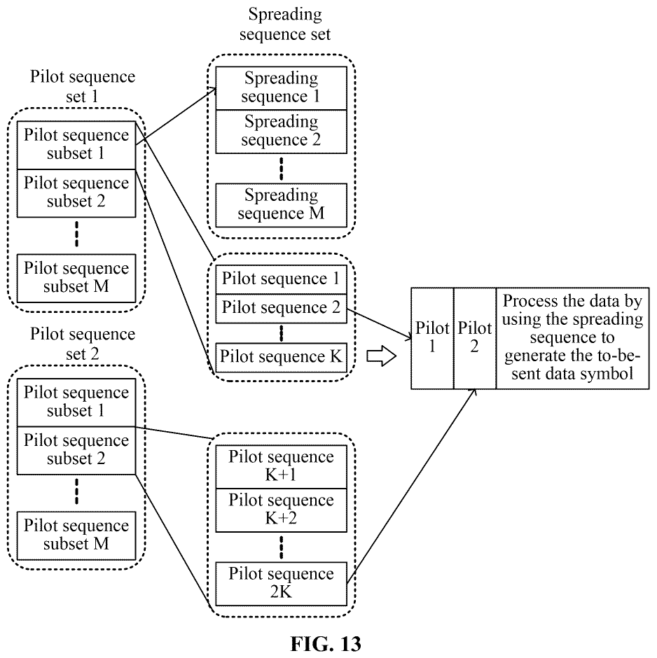

FIG. 13 is schematic diagram one illustrating the association relationship between pilot sequences and spreading sequences according to fourth embodiment of the present application. First, the transmitter randomly selects a pilot sequence subset (pilot sequence subset 1) from pilot sequence set 1 and randomly selects a pilot sequence (pilot sequence 2) from pilot sequence subset 1 as pilot 1.

In this embodiment, the pilot sequence subsets are in one-to-one correspondence with the spreading sequences. According to the one-to-one correspondence between the pilot sequence subsets and the spreading sequences, the transmitter selects spreading sequence 1 in the spreading sequence set as the spreading sequence.

In this embodiment, the pilot sequence subsets to which the pilot sequences of pilot 1 and pilot 2 belong are from different pilot sequence sets and are associated with each other.

The transmitter randomly selects a pilot sequence (pilot sequence 2K) from a pilot sequence subset (pilot sequence subset 2) in pilot sequence set 2 associated with pilot sequence subset 1 in pilot sequence set 1 as pilot 2.

In an example, an association relationship between pilot sequence subsets of different pilot sequence sets may be expressed by formula (2).

FIG. 13 may be considered as that the transmitter randomly selects pilot sequences from pilot sequence subsets with different indices in different pilot sequence sets as pilot 1 and pilot 2, respectively, or the pilot sequences of the two pilots are from the pilot sequence subsets with different indices in different pilot sequence sets.

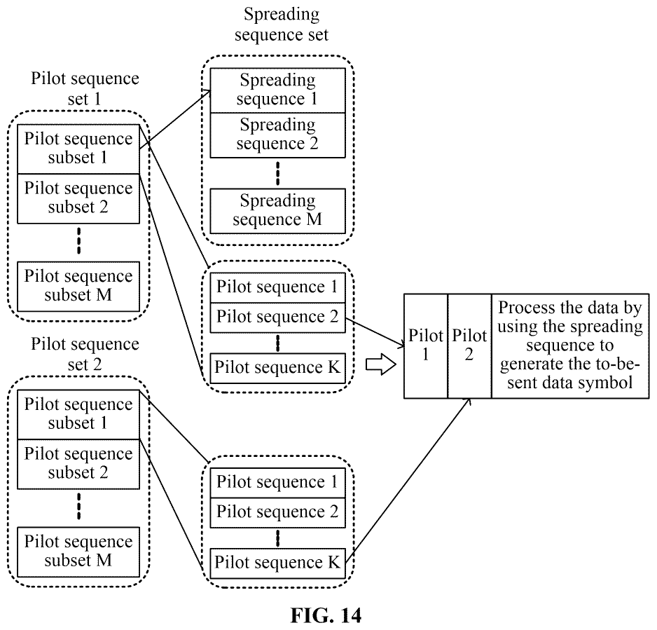

FIG. 14 is schematic diagram two illustrating the association relationship between pilot sequences and spreading sequences according to fourth embodiment of the present application. FIG. 14 may be considered as the case where z=0 in formula (2), that is, the transmitter randomly selects pilot sequences from the pilot sequence subsets with the same index in different pilot sequence sets as pilot 1 and pilot 2, respectively, or the pilot sequences of the two pilots are from the pilot sequence subsets with the same index in different pilot sequence sets.

In addition, the association relationship between the spreading sequence and the first pilot sequence subset group may also be established in the fourth embodiment. The first pilot sequence subset group and the second pilot sequence subset group belong to different pilot sequence sets and are associated with each other. The first pilot sequence subset group and the second pilot sequence subset group each include at least one pilot sequence subset. First, the transmitter selects the first pilot sequence subset group from pilot sequence set 1 and selects at least one pilot sequence from the first pilot sequence subset group. The spreading sequence is determined according to the association relationship between the spreading sequence and the first pilot sequence subset group. According to the association relationship between the first pilot sequence subset group and the second pilot sequence subset group, the second pilot sequence subset group in pilot sequence set 2 is determined and at most N−1 pilot sequences are selected from the second pilot sequence subset group.

In fourth embodiment, 2M pilot sequence subsets of two different pilot sequence sets may also be grouped into M pilot sequence subset groups. Reference is made to FIGS. 9 and 12, and the details are not repeated.

### Fifth Embodiment

In third embodiment and fourth embodiment, the transmitter selects the pilot sequence subset (group), then determines the spreading sequence, and selects the pilot sequences. In this embodiment, the transmitter selects the pilot sequence and then determines the pilot sequence subset (group) to which the pilot sequence belongs and the corresponding spreading sequence.

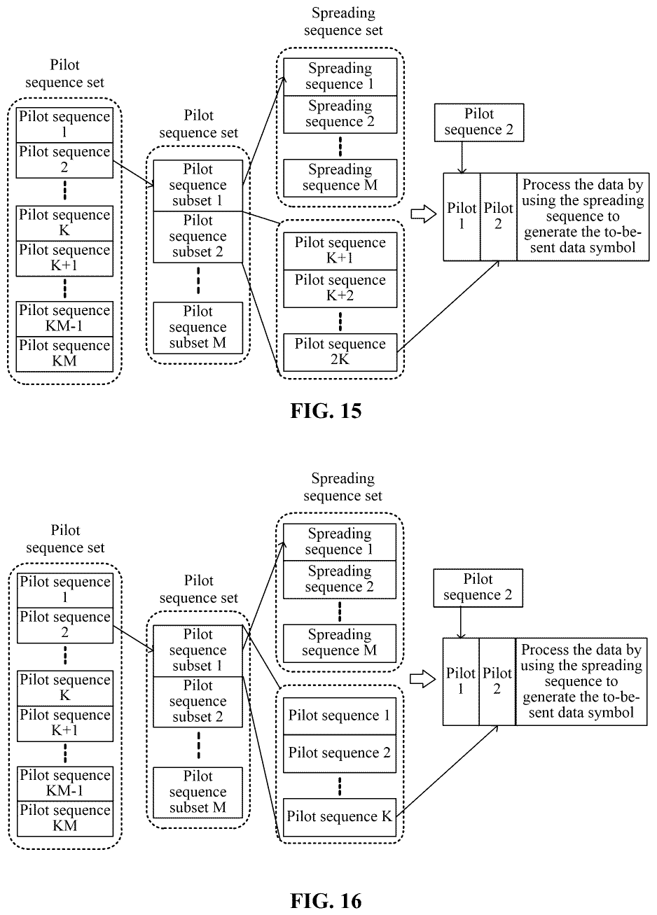

FIG. 15 is schematic diagram one illustrating the association relationship between pilot sequences and spreading sequences according to fifth embodiment of the present application. First, the transmitter randomly selects a pilot sequence (pilot sequence 2) from the pilot sequence set as pilot 1 and determines that the randomly selected pilot sequence 2 belongs to pilot sequence subset 1.

In this embodiment, the pilot sequence subsets are in one-to-one correspondence with the spreading sequences.

According to the one-to-one correspondence between the pilot sequence subsets and the spreading sequences, the transmitter selects spreading sequence 1 in the spreading sequence set as the spreading sequence.

In this embodiment, the pilot sequence subsets to which the pilot sequences of pilot 1 and pilot 2 belong are from the same pilot sequence set and are associated with each other.

The transmitter randomly selects a pilot sequence (pilot sequence 2K) from a pilot sequence subset (pilot sequence subset 2) associated with pilot sequence subset 1 as pilot 2.

In an example, an association relationship between the pilot sequence subsets may be expressed by formula (1).

FIG. 16 is schematic diagram two illustrating the association relationship between pilot sequences and spreading sequences according to fifth embodiment of the present application. FIG. 16 may be considered as the case where z=0 in formula (1).

In addition, the association relationship between the spreading sequence and the first pilot sequence subset group may also be established in fifth embodiment. First, the transmitter randomly selects a pilot sequence from the pilot sequence set as pilot 1 and determines the first pilot sequence subset group to which the randomly selected pilot sequence belongs. The spreading sequence used by the transmitter is determined according to the association relationship between the spreading sequence and the first pilot sequence subset group. The first pilot sequence subset group and the second pilot sequence subset group belong to the same pilot sequence set and are associated with each other. The transmitter selects N−1 pilot sequences from the second pilot sequence subset group associated with the first pilot sequence subset group. The first pilot sequence subset group includes one pilot sequence subset, and the second pilot sequence subset group includes at least one pilot sequence subset. In an example, the association relationship between the first pilot sequence subset group and the second pilot sequence subset group may be expressed by formula (1). Specifically, the association relationship between the pilot sequence subset in the first pilot sequence subset group and the first pilot sequence subset in the second pilot sequence subset group may be expressed by formula (1). Alternatively, the association relationship between a pilot sequence subset in the first pilot sequence subset group and a pilot sequence subset in the second pilot sequence subset group may be expressed by formula (1).

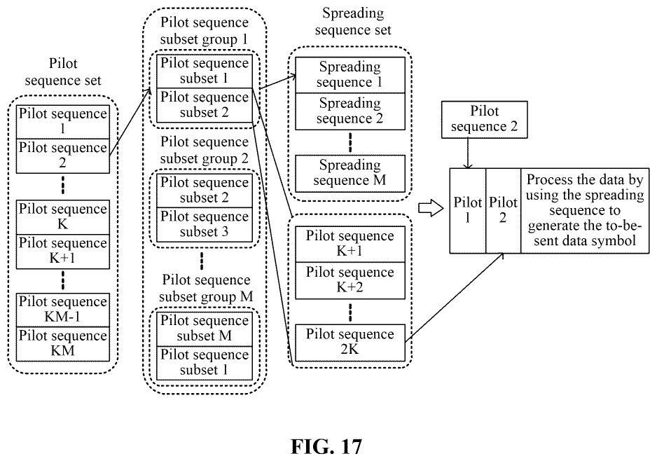

FIG. 17 is schematic diagram three illustrating the association relationship between pilot sequences and spreading sequences according to fifth embodiment of the present application. As shown in FIG. 17, each pilot sequence subset group includes two pilot sequence subsets. In FIG. 17, each pilot sequence subset group includes two different pilot sequence subsets, and the interval or offset z between the two different pilot sequence subsets is 1, which corresponds to FIG. 15. The case where each pilot sequence subset group in FIG. 17 includes two identical pilot sequence subsets, that is, the interval or offset z of the pilot sequence subsets is 0 (no interval or offset parameter z exists), corresponds to FIG. 16.

First, the transmitter randomly selects a pilot sequence (pilot sequence 2) from the pilot sequence set as pilot 1 and determines that the randomly selected pilot sequence 2 belongs to pilot sequence subset 1 in pilot sequence subset group 1.

In this embodiment, the pilot sequence subset groups are in one-to-one correspondence with the spreading sequences.

According to the one-to-one correspondence between the pilot sequence subset groups and the spreading sequences, the transmitter selects spreading sequence 1 in the spreading sequence set as the spreading sequence.

The transmitter randomly selects a pilot sequence (pilot sequence 2K) from pilot sequence subset 2 in pilot sequence subset group 1 as pilot 2. In this embodiment, the pilot sequence subsets in the pilot sequence subset group are from the same pilot sequence set.

In an example, the transmitter may randomly select a pilot sequence from the pilot sequence set or indicate a pilot sequence in the pilot sequence set according to the designated data in the data.

### Sixth Embodiment

In fifth embodiment, the pilot sequences of the two pilots are from the same pilot sequence set. In this embodiment, the pilot sequences of the two pilots are from different pilot sequence sets.

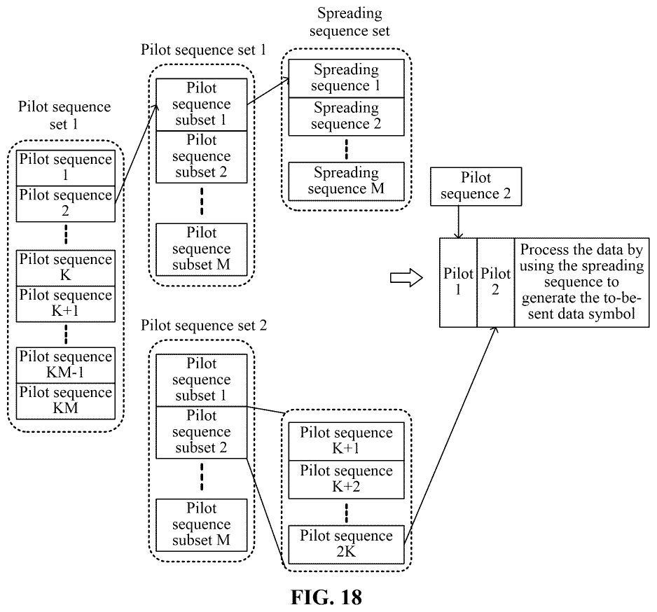

FIG. 18 is schematic diagram one illustrating the association relationship between pilot sequences and spreading sequences according to sixth embodiment of the present application. First, the transmitter randomly selects a pilot sequence (pilot sequence 2) from pilot sequence set 1 as pilot 1 and determines that the randomly selected pilot sequence 2 belongs to pilot sequence subset 1.

In this embodiment, the pilot sequence subsets are in one-to-one correspondence with the spreading sequences.

According to the one-to-one correspondence between the pilot sequence subsets and the spreading sequences, the transmitter selects spreading sequence 1 in the spreading sequence set as the spreading sequence.

In this embodiment, the pilot sequence subsets to which the pilot sequences of pilot 1 and pilot 2 belong are from different pilot sequence sets and are associated with each other.

The transmitter randomly selects a pilot sequence (pilot sequence 2K) from a pilot sequence subset (pilot sequence subset 2) in pilot sequence set 2 associated with pilot sequence subset 1 in pilot sequence set 1 as pilot 2.

In an example, an association relationship between the pilot sequence subsets of different pilot sequence sets may be expressed by formula (2).

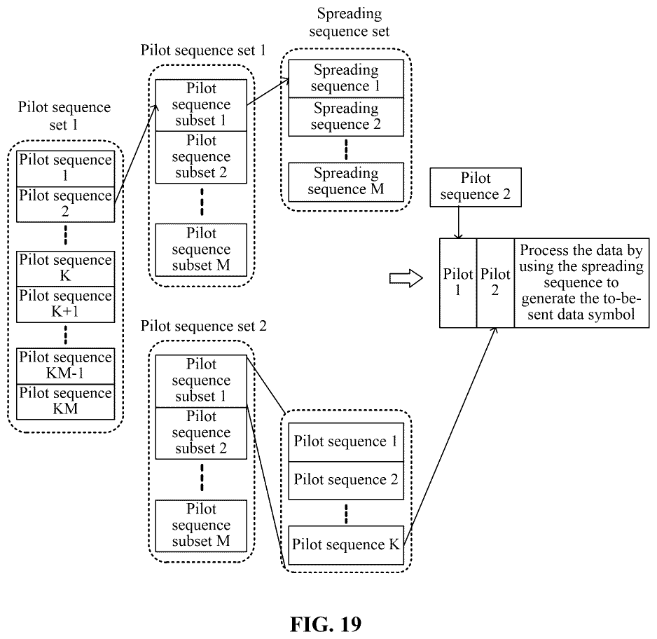

FIG. 19 is schematic diagram two illustrating the association relationship between pilot sequences and spreading sequences according to sixth embodiment of the present application. FIG. 19 may be considered as the case where z=0 in formula (2).

In addition, the association relationship between the spreading sequence and the first pilot sequence subset group may also be established in the sixth embodiment. The first pilot sequence subset group and the second pilot sequence subset group belong to different pilot sequence sets and are associated with each other. First, the transmitter randomly selects a pilot sequence from pilot sequence set 1 as pilot 1 and determines the first pilot sequence subset group to which the randomly selected pilot sequence belongs. The spreading sequence used by the transmitter is determined according to the association relationship between the spreading sequence and the first pilot sequence subset group. The transmitter randomly selects N−1 pilot sequences from the second pilot sequence subset group in pilot sequence set 2 associated with the first pilot sequence subset group. The first pilot sequence subset group includes one pilot sequence subset, and the second pilot sequence subset group includes at least one pilot sequence subset. In an example, the association relationship between the first pilot sequence subset group and the second pilot sequence subset group may be expressed by formula (2). Specifically, the association relationship between the pilot sequence subset in the first pilot sequence subset group and the first pilot sequence subset in the second pilot sequence subset group may be expressed by formula (2). Alternatively, the association relationship between the pilot sequence subset in the first pilot sequence subset group and a pilot sequence subset in the second pilot sequence subset group may be expressed by formula (2).

In sixth embodiment, 2M pilot sequence subsets of two different pilot sequence sets may also be grouped into M pilot sequence subset groups. Reference is made to FIG. 17, and the details are not repeated.

### Seventh Embodiment

First embodiment to sixth embodiment explicitly propose the concept of the pilot sequence subset. In this embodiment, there is no concept of the subset, or the concept of the subset is expressed implicitly.

In this embodiment, the parameters are redetermined. The size of the spreading sequence set is M, and the size of the pilot sequence set is J.

To facilitate the description of the embodiment, the parameters are specified in the embodiment. The size M of the spreading sequence set is 16, that is, the spreading sequence set includes 16 spreading sequences; and the size J of the pilot sequence set is 144, that is, the pilot sequence set includes 144 pilot sequences. The number N of pilots at the transmitter is 2, that is, the user sends two pilots which are pilot 1 and pilot 2. The present application does not limit the specific values of the preceding parameters, and those skilled in the art can determine the values of the parameters according to actual situations.

In this embodiment, the transmitter selects a pilot sequence and then determines the spreading sequence and the other N−1 pilot sequences.

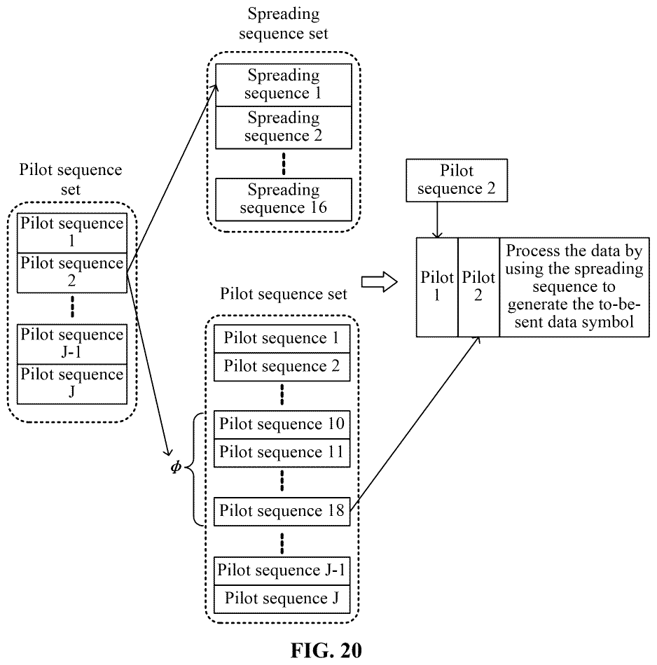

FIG. 20 is schematic diagram one illustrating the association relationship between pilot sequences and spreading sequences according to seventh embodiment of the present application. First, the transmitter randomly selects a pilot sequence (pilot sequence j1, j1=2) from the pilot sequence set as pilot 1. j1 denotes the pilot sequence (index) of pilot 1.

The transmitter determines spreading sequence m according to pilot sequence j1, where j1=1, 2, . . . , J, and m=1, 2, . . . , M. In an example, the transmitter may determine spreading sequence m according to formula (3).

$$m = ceil ( \frac{j 1}{ceil ( J / M )} ) \qquad ( 3 )$$

ceil denotes ceiling.

According to formula (3), m equal to 1 is obtained through calculation, that is, the transmitter determines spreading sequence 1 as the spreading sequence.

The transmitter determines the pilot sequence range φ of pilot 2 and randomly selects pilot sequence j2 from the range as pilot 2. j2 denotes the pilot sequence (index) of pilot 2.

In an example, φ may be determined according to formulas (4) and (5).

$$ϕ = \{ ( u - 1 ) \times ceil ( J / M ) + 1 , ( u - 1 ) \times ceil ( J / M ) + 2 , … , u \times ceil ( J / M ) \} \qquad ( 4 )$$

$$u = mod ( m + q - 1 , M ) + 1 , 0 \leq q \leq M - 1 \qquad ( 5 )$$

In FIG. 20, with m=1 and q=1, u=2 and φ={10, 11, . . . , 18} are obtained through calculation, and the transmitter randomly selects pilot sequence 18 (j2=18) from φ as pilot 2. The value of q is known to the transmitter and the receiver. For example, the receiver notifies the transmitter of the value of q via broadcasting. The method for determining φ is known to both the transmitter and the receiver.

In an example,

$$u = mod ( ceil ( \frac{j 1}{ceil ( J / M )} ) + q - 1 , M ) + 1 , 0 \leq q \leq M - 1 \qquad ( 6 )$$

The difference between formula (5) and formula (6) is as follows: for formula (5), the pilot sequence range φ of pilot 2 is related to spreading sequence m; and for formula (6), the pilot sequence range φ of pilot 2 may be determined through pilot sequence j1 of pilot 1.

In this embodiment, the pilot sequences of pilot 1 and pilot 2 are from the same pilot sequence set and are associated with each other.

In an example, the transmitter may randomly select a pilot sequence from the pilot sequence set or indicate a pilot sequence in the pilot sequence set according to the designated data in the data.

### Eighth Embodiment

In seventh embodiment, the pilot sequences of the two pilots are from the same pilot sequence set. In this embodiment, the pilot sequences of the two pilots are from different pilot sequence sets.

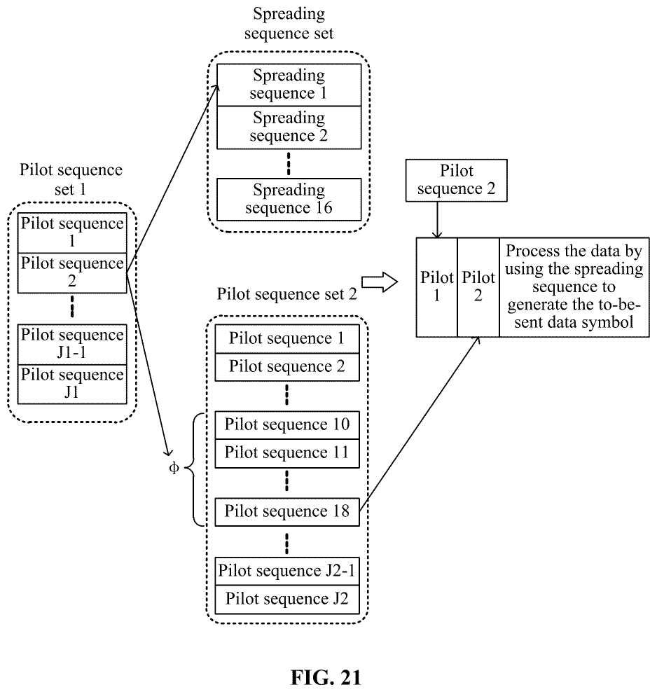

FIG. 21 is schematic diagram one illustrating the association relationship between pilot sequences and spreading sequences according to eighth embodiment of the present application. First, the transmitter randomly selects a pilot sequence (pilot sequence j1, j1=2) from pilot sequence set 1 as pilot 1. j1 denotes the pilot sequence (index) of pilot 1.

The transmitter determines spreading sequence m according to pilot sequence j1, where j1=1, 2, . . . , J1, and m=1, 2, . . . , M. In an example, the transmitter may determine spreading sequence m according to formula (7).

$$m = ceil ( \frac{j 1}{ceil ( J 1 / M )} ) \qquad ( 7 )$$

J1 denotes the size of pilot sequence set 1. The case where J1=144 is used as an example. According to formula (7), m equal to 1 is obtained through calculation, that is, the transmitter determines spreading sequence 1 as the spreading sequence.

The transmitter determines the pilot sequence range φ of pilot 2 in pilot sequence set 2 and randomly selects pilot sequence j2 from the range as pilot 2. j2 denotes the pilot sequence (index) of pilot 2.

In an example, φ may be determined according to formulas (8) and (9).

$$ϕ = \{ ( u - 1 ) \times ceil ( J 2 / M ) + 1 , ( u - 1 ) \times ceil ( J 2 / M ) + 2 , … , u \times ceil ( J 2 / M ) \} \qquad ( 8 )$$

$$u = mod ( m + q - 1 , M ) + 1 , 0 \leq q \leq M - 1 \qquad ( 9 )$$

J2 denotes the size of pilot sequence set 2. The case where J2=144 is used as an example. In FIG. 21, with m=1 and q=1, u=2 and φ={10, 11, . . . , 18} are obtained through calculation, and the transmitter randomly selects pilot sequence 18 (j2=18) from φ of pilot sequence set 2 as pilot 2. The value of q is known to the transmitter and the receiver. For example, the receiver notifies the transmitter of the value of q via broadcasting. The method for determining φ is known to both the transmitter and the receiver.

In an example,

$$u = mod ( ceil ( \frac{j 1}{ceil ( J 1 / M )} ) + q - 1 \cdot M ) + 1 \cdot 0 \leq q \leq M - 1 \qquad ( 10 )$$

The difference between formula (9) and formula (10) is as follows: for formula (9), the pilot sequence range φ of pilot 2 is related to spreading sequence m; and for formula (10), the pilot sequence range φ of pilot 2 may be determined through pilot sequence j1 of pilot 1.

In this embodiment, the pilot sequences of pilot 1 and pilot 2 are from different pilot sequence sets and are associated with each other.

In an example, the size J1 of pilot sequence set 1 and the size J2 of pilot sequence set 2 may be the same (J1=J2) or different (J1≠J2).

In the methods shown in seventh embodiment and eighth embodiment, there is no concept of the pilot sequence subset, the methods may also be used in first embodiment and second embodiment, and the details are not repeated.

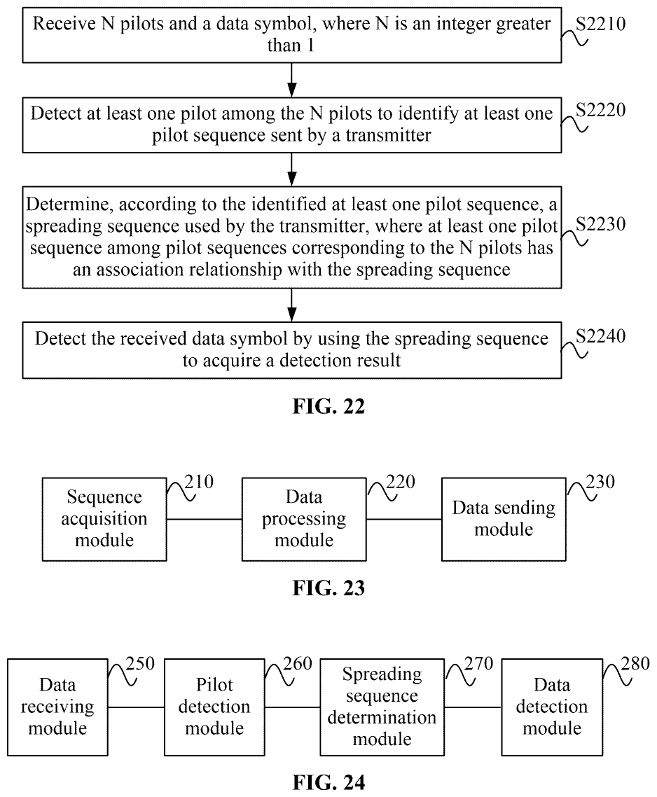

FIG. 22 is a flowchart of another data transmission method according to an embodiment of the present application. As shown in FIG. 22, the data transmission method provided in this embodiment includes the following:

In S2210, N pilots and a data symbol are received, where N is an integer greater than 1.

The data transmission method provided in this embodiment is used for data reception and is performed by a data receiver in the network. The receiver may be a base station, an access point, a receiver, or the like. The receiver may receive the uplink data sent by the transmitter, and the transmitter may use contention-based resources to perform uplink grant-free data transmission. The data transmission method provided in this embodiment is used for implementing contention-based grant-free transmission based on the combination of multiple pilots and the spreading sequence. The data transmission method provided in this embodiment is used in conjunction with the data transmission method at the transmitter shown in FIG. 1, and in the data transmission method provided in this embodiment, the pilot sequences and the data symbol sent through the data transmission method shown in FIG. 1 are received.

First, for the transmitter adopting the multi-pilot design, N pilots and a data symbol are sent each time, and the receiver receives the N pilots and the data symbol sent by the transmitter. The data symbol has been processed by the spreading sequence.

In S2220, at least one pilot among the N pilots is detected to identify at least one pilot sequence sent by a transmitter.

The receiver may detect any one of the N received pilots, or the receiver may detect all the N received pilots. At least one of the N pilots is detected so that at least one pilot sequence sent by the transmitter may be identified.

In S2230, a spreading sequence used by the transmitter is determined according to the identified pilot sequence, and at least one pilot sequence among pilot sequences corresponding to the N pilots has an association relationship with the spreading sequence.

When the transmitter sends the pilot sequences and the data symbol, the data symbol is obtained through processing by the spreading sequence, where the spreading sequence has an association relationship with at least one pilot among the pilot sequences corresponding to the N pilots. The association relationship between the pilot sequences corresponding to the N pilots and the spreading sequences is described in detail in the embodiment shown in FIG. 1, and the details are not repeated here. To sum up, the receiver and the transmitter are configured with the same association relationship between the pilot sequences and the spreading sequences. In this manner, after the receiver identifies at least one pilot sequence sent by the transmitter, according to the association relationship between the at least one pilot sequence and the spreading sequences, the receiver can determine the spreading sequence used by the transmitter.

In S2240, the received data symbol is detected by using the spreading sequence to acquire a detection result.

Finally, after the spreading sequence used by the transmitter is identified, the received data symbol is detected using the spreading sequence, thereby completing data reception. The method for detecting the received data symbol using the spreading sequence is well known to those skilled in the art, and the details are not repeated here.

In the data transmission method provided in this embodiment, the N pilots and the data symbol sent through the data transmission method provided in the embodiment shown in FIG. 1 are received. At least one pilot among the N pilots is detected, the pilot sequence sent by the transmitter is identified, and the spreading sequence used by the transmitter to send the data symbol is determined according to the association relationship between the pilot sequences and the spreading sequences, thereby achieving the signal reception in the data transmission using multiple pilots and spreading. The specific association relationship between the pilot sequences and the spreading sequences is described in detail in the embodiment shown in FIG. 1, and the details are not repeated here.

In an embodiment, at least one pilot among the N pilots is detected to identify at least one pilot sequence sent by the transmitter, which also completes the detection of an active user. That is to say, one identified pilot sequence corresponds to one transmitter for sending data, that is, the pilot detection and the detection of an active user are performed simultaneously.

In an embodiment, at least one pilot among the N pilots is detected to identify at least one pilot sequence sent by the transmitter, which also completes channel estimation, that is, pilot detection and channel estimation are performed simultaneously.

After the N pilots are received and at least one pilot among the N pilots is detected to identify at least one pilot sequence sent by the transmitter, in addition to further determining the spreading sequence used by the transmitter, channel estimation may be performed according to the identified pilot sequence to determine the channel state between the transmitter and the receiver, that is, pilot detection and channel estimation are not performed separately. In conjunction with the embodiment shown in FIG. 22, after the receiver receives the N pilots and detects at least one of the N pilots to identify at least one pilot sequence sent by the transmitter, at least one of the following may be implemented: determining the spreading sequence used by the transmitter according to the identified pilot sequence; performing the detection of an active user; or performing channel estimation according to the identified pilot sequence.

In an embodiment, determining the spreading sequence used by the transmitter according to the identified pilot sequence includes: determining, according to the identified at least one pilot sequence, a pilot sequence subset to which the identified at least one pilot sequence belongs and determining the spreading sequence corresponding to the pilot sequence subset; determining, according to the identified at least one pilot sequence, a pilot sequence subset group to which the identified at least one pilot sequence belongs and determining the spreading sequence corresponding to the pilot sequence subset group; or determining, according to the identified at least one pilot sequence, the spreading sequence associated with the at least one pilot sequence.

According to the embodiment shown in FIG. 1, it can be seen that the N pilot sequences may belong to one or more pilot sequence sets, and each pilot sequence set may include multiple pilot sequence subsets. The pilot sequence subsets may be grouped into pilot sequence subset groups, and each pilot sequence subset group includes at least one pilot sequence subset. Each pilot sequence subset includes at least one pilot sequence. In this manner, after identifying at least one pilot sequence sent by the transmitter, the receiver may determine the spreading sequence used by the transmitter according to the association relationship between the pilot sequences and the spreading sequences. If an association relationship exists between the pilot sequences and the spreading sequences, the spreading sequence corresponding to the pilot sequence may be directly determined according to the identified at least one pilot sequence. If an association relationship exists between the pilot sequence subsets and the spreading sequences, the pilot sequence subset to which the identified pilot sequence belongs may be determined according to the identified pilot sequence, and then the spreading sequence corresponding to the pilot sequence subset may be further determined. If an association relationship exists between the pilot sequence subset groups and the spreading sequences, the pilot sequence subset group to which the identified pilot sequence belongs may be determined according to the identified pilot sequence, and then the spreading sequence corresponding to the pilot sequence subset group may be further determined.

In an embodiment, after the received data symbol is detected using the spreading sequence to acquire the detection result, the method further includes demodulating and decoding the detection result to acquire the data sent by the transmitter.

For the transmitter that is demodulated and decoded correctly, the receiver may reconstruct the N pilots and the data symbol of the transmitter and cancel the N pilots and the data symbol from the received N pilots and data symbols, thereby improving the detection performance for other transmitters.

In an embodiment, the data sent by the transmitter includes at least one of the following: user identity information, service data, the information about the N pilots corresponding to the N pilot sequences, or the information about the spreading sequence. The information about a pilot includes a pilot sequence index.

FIG. 23 is a diagram illustrating the structure of a data transmission apparatus according to an embodiment of the present application. As shown in FIG. 23, the data transmission apparatus provided in this embodiment includes a sequence acquisition module 210, a data processing module 220, and a data sending module 230.

The sequence acquisition module 210 is configured to acquire N pilot sequences and a spreading sequence, at least one pilot sequence among the N pilot sequences has an association relationship with the spreading sequence, and N is an integer greater than 1. The data processing module 220 is configured to process to-be-sent data by using the spreading sequence to generate a to-be-sent data symbol. The data sending module 230 is configured to send the N pilot sequences and the to-be-sent data symbol.

The data transmission apparatus provided in this embodiment is disposed at the data transmitter and is configured to perform the data transmission method of the embodiment shown in FIG. 1. The implementation principle and technical effect of the data transmission apparatus are similar to those of the data transmission method. The details are not repeated here.

FIG. 24 is a diagram illustrating the structure of another data transmission apparatus according to an embodiment of the present application. As shown in FIG. 24, the data transmission apparatus provided in this embodiment includes a data receiving module 250, a pilot detection module 260, a spreading sequence determination module 270, and a data detection module 280.

The data receiving module 250 is configured to receive N pilots and a data symbol, where N is an integer greater than 1. The pilot detection module 260 is configured to detect at least one pilot among the N pilots to identify at least one pilot sequence sent by a transmitter. The spreading sequence determination module 270 is configured to determine, according to the identified at least one pilot sequence, a spreading sequence used by the transmitter, and at least one pilot sequence among pilot sequences corresponding to the N pilots has an association relationship with the spreading sequence. The data detection module 280 is configured to detect the received data symbol using the spreading sequence.

The data transmission apparatus provided in this embodiment is disposed at the data receiver and is configured to perform the data transmission method of the embodiment shown in FIG. 22. The implementation principle and technical effect of the data transmission apparatus are similar to those of the data transmission method. The details are not repeated here.

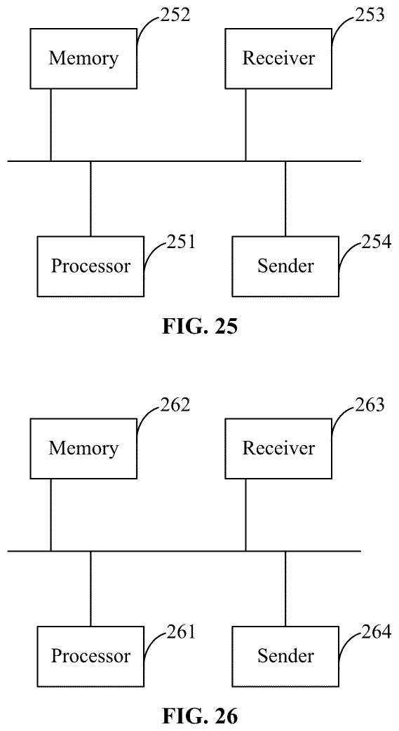

FIG. 25 is a diagram illustrating the structure of a data transmission device according to an embodiment of the present application. As shown in FIG. 25, the data transmission device includes a processor 251, a memory 252, a receiver 253, and a sender 254. One or more processors 251 may be provided in the data transmission device, and one processor 251 is shown as an example in FIG. 25. The processor 251, the memory 252, the receiver 253, and the sender 254 in the data transmission device may be connected via a bus or in other manners. In FIG. 25, the connection via a bus is shown as an example.

As a computer-readable storage medium, the memory 252 is configured to store software programs, computer-executable programs, and modules, for example, program instructions/modules (the sequence acquisition module 210, the data processing module 220, and the data sending module 230) corresponding to the data transmission method of the embodiment shown in FIG. 23 of the present application. The processor 251 is configured to execute the software programs, instructions, and modules stored in the memory 252 to perform various functions and data processing of the data transmission device, that is, to implement the data transmission method.

The memory 252 may mainly include a program storage region and a data storage region. The program storage region may store an operating system and an application program required by at least one function. The data storage region may store data created according to the use of the data transmission device. Additionally, the memory 252 may include a high-speed random-access memory and may further include a non-volatile memory such as at least one magnetic disk memory, a flash memory, or another non-volatile solid-state memory.

The receiver 253 is any device/module having a data receiving capability or a combination of more devices/modules having the data receiving capability. The sender 254 is any device/module having a data sending capability or a combination of more devices/modules having the data sending capability.

FIG. 26 is a diagram illustrating the structure of another data transmission device according to an embodiment of the present application. As shown in FIG. 26, the data transmission device includes a processor 261, a memory 262, a receiver 263, and a sender 264. One or more processors 261 may be provided in the data transmission device, and one processor 261 is shown as an example in FIG. 26. The processor 261, the memory 262, the receiver 263, and the sender 264 in the data transmission device may be connected via a bus or in other manners. In FIG. 26, the connection via a bus is shown as an example.

As a computer-readable storage medium, the memory 262 is configured to store software programs, computer-executable programs, and modules, for example, program instructions/modules (the data receiving module 250, the pilot detection module 260, the spreading sequence determination module 270, and the data detection module 280) corresponding to the data transmission method of the embodiment shown in FIG. 24 of the present application. The processor 261 is configured to execute the software programs, instructions, and modules stored in the memory 262 to perform various functions and data processing of the data transmission device, that is, to implement the data transmission method.

The memory 262 may mainly include a program storage region and a data storage region. The program storage region may store an operating system and an application program required by at least one function. The data storage region may store data created according to the use of the data transmission device. Additionally, the memory 262 may include a high-speed random-access memory and may further include a non-volatile memory such as at least one magnetic disk memory, a flash memory, or another non-volatile solid-state memory.

The receiver 263 is any device/module having a data receiving capability or a combination of more devices/modules having the data receiving capability. The sender 264 is any device/module having a data sending capability or a combination of more devices/modules having the data sending capability.

An embodiment of the present application further provides a storage medium storing computer-executable instructions which, when executed by a computer processor, cause the processor to perform a data transmission method. The method includes acquiring N pilot sequences and a spreading sequence, where at least one pilot sequence among the N pilot sequences has an association relationship with the spreading sequence, and N is an integer greater than 1; processing to-be-sent data by using the spreading sequence to generate a to-be-sent data symbol; and sending the N pilot sequences and the to-be-sent data symbol.

An embodiment of the present application further provides a storage medium storing computer-executable instructions which, when executed by a computer processor, cause the processor to perform a data transmission method. The method includes receiving N pilots and a data symbol, where N is an integer greater than 1; detecting at least one pilot among the N pilots to identify at least one pilot sequence sent by a transmitter; determining, according to the identified at least one pilot sequence, a spreading sequence used by the transmitter, where at least one pilot sequence among pilot sequences corresponding to the N pilots has an association relationship with the spreading sequence; and detecting the received data symbol using the spreading sequence to acquire a detection result.

The implementation manners disclosed in the present application are intended to facilitate the understanding of the technical solutions of the present application and not to limit the present application. Any person skilled in the art to which the present application pertains may make any modifications and changes in the form and details of implementation without departing from the core technical solutions disclosed in the present application, but the scope of the present application is still subject to the scope defined by the appended claims.

1. A data transmission method, comprising:
acquiring N pilot sequences and a spreading sequence, wherein at least one pilot sequence among the N pilot sequences has an association relationship with the spreading sequence, and N is an integer greater than 1;
processing to-be-sent data by using the spreading sequence to generate a to-be-sent data symbol; and
sending the N pilot sequences and the to-be-sent data symbol.

2. The data transmission method of claim 1, wherein acquiring the N pilot sequences and the spreading sequence comprises:
acquiring the spreading sequence, and acquiring the N pilot sequences according to the spreading sequence.

3. The data transmission method of claim 1, wherein acquiring the N pilot sequences and the spreading sequence comprises:
acquiring the at least one pilot sequence, and acquiring the spreading sequence and other at most N−1 pilot sequences according to the at least one pilot sequence.

4. The data transmission method of claim 1, wherein acquiring the N pilot sequences and the spreading sequence comprises one of the following:
acquiring at least one pilot sequence subset, and acquiring the spreading sequence and the N pilot sequences according to the at least one pilot sequence subset; or
acquiring at least one pilot sequence subset group, and acquiring the spreading sequence and the N pilot sequences according to the at least one pilot sequence subset group.

5. The data transmission method of claim 4, wherein the spreading sequence has an association relationship with the at least one pilot sequence subset, or the spreading sequence has an association relationship with the at least one pilot sequence subset group.

6. The data transmission method of claim 2, wherein acquiring the spreading sequence and acquiring the N pilot sequences according to the spreading sequence comprises one of the following:
acquiring the spreading sequence, and acquiring the N pilot sequences from a pilot sequence subset associated with the spreading sequence;
acquiring the spreading sequence, and acquiring the N pilot sequences from a pilot sequence subset group associated with the spreading sequence; or
acquiring the spreading sequence, acquiring at least one pilot sequence from a first pilot sequence subset group associated with the spreading sequence, and acquiring other at most N−1 pilot sequences from a second pilot sequence subset group associated with the first pilot sequence subset group.

7. The data transmission method of claim 3, wherein acquiring the at least one pilot sequence and acquiring the spreading sequence and the other at most N−1 pilot sequences according to the at least one pilot sequence comprises one of the following:
acquiring a first pilot sequence, acquiring the spreading sequence according to the first pilot sequence, and acquiring the other N−1 pilot sequences according to the first pilot sequence or the spreading sequence;
acquiring a first pilot sequence, determining a pilot sequence subset to which the first pilot sequence belongs, acquiring the spreading sequence associated with the pilot sequence subset, and acquiring the other N−1 pilot sequences from the pilot sequence subset;
acquiring a first pilot sequence, determining a pilot sequence subset group to which the first pilot sequence belongs, acquiring the spreading sequence associated with the pilot sequence subset group, and acquiring the other N−1 pilot sequences from the pilot sequence subset group; or
acquiring a first pilot sequence, determining a first pilot sequence subset group to which the first pilot sequence belongs, acquiring the spreading sequence associated with the first pilot sequence subset group, and acquiring the other N−1 pilot sequences from a second pilot sequence subset group associated with the first pilot sequence subset group.

8. The data transmission method of claim 4, wherein acquiring the at least one pilot sequence subset and acquiring the spreading sequence and the N pilot sequences according to the at least one pilot sequence subset comprises:
acquiring a pilot sequence subset, acquiring the spreading sequence associated with the pilot sequence subset, and acquiring the N pilot sequences from the pilot sequence subset; and
wherein acquiring the at least one pilot sequence subset group and acquiring the spreading sequence and the N pilot sequences according to the at least one pilot sequence subset group comprises one of the following:
acquiring a pilot sequence subset group, acquiring the spreading sequence associated with the pilot sequence subset group, and acquiring the N pilot sequences from the pilot sequence subset group; or
acquiring a first pilot sequence subset group, acquiring the spreading sequence associated with the first pilot sequence subset group, acquiring at least one pilot sequence from the first pilot sequence subset group, and acquiring other at most N−1 pilot sequences from a second pilot sequence subset group associated with the first pilot sequence subset group.

9. The data transmission method of claim 1, wherein a pilot sequence of the N pilot sequences comprises at least one of the following: a Zadoff-Chu (ZC) sequence, a Hadamard sequence, a Walsh sequence, or a Walsh-Hadamard sequence.

10. The data transmission method of claim 1, wherein processing the to-be-sent data by using the spreading sequence to generate the to-be-sent data symbol comprises:
spreading, modulating, or mapping the to-be-sent data by using the spreading sequence to generate the to-be-sent data symbol.

11. The data transmission method of claim 1, wherein sending the N pilot sequences and the to-be-sent data symbol comprises:
generating a signal according to the N pilot sequences and the to-be-sent data symbol, and sending the signal; or
generating a signal corresponding to N pilots according to the N pilot sequences and sending the signal; and generating a signal according to the to-be-sent data symbol and sending the signal.

12. The data transmission method of claim 1, wherein the to-be-sent data comprises at least one of the following pieces of information:
user identity information;
service data;
information about N pilots corresponding to the N pilot sequences; or
information about the spreading sequence.

13. The data transmission method of claim 1, wherein acquiring the N pilot sequences and the spreading sequence comprises at least one of the following:
acquiring the spreading sequence according to the to-be-sent data;
acquiring at least one pilot sequence among the N pilot sequences according to the to-be-sent data; or
acquiring, according to the to-be-sent data, at least one pilot sequence subset associated with the spreading sequence.

14. A data transmission method, comprising:
receiving N pilots and a data symbol, wherein Nis an integer greater than 1;
detecting at least one pilot among the N pilots to identify at least one pilot sequence sent by a transmitter;
determining, according to the identified at least one pilot sequence, a spreading sequence used by the transmitter, wherein at least one pilot sequence among pilot sequences corresponding to the N pilots has an association relationship with the spreading sequence; and
detecting the received data symbol by using the spreading sequence to acquire a detection result.

15. The data transmission method of claim 14, wherein determining, according to the identified at least one pilot sequence, the spreading sequence used by the transmitter comprises at least one of the following:
determining, according to the identified at least one pilot sequence, a pilot sequence subset to which the identified at least one pilot sequence belongs, and determining the spreading sequence associated with the pilot sequence subset;
determining, according to the identified at least one pilot sequence, a pilot sequence subset group to which the identified at least one pilot sequence belongs, and determining the spreading sequence associated with the pilot sequence subset group; or
determining, according to the identified at least one pilot sequence, the spreading sequence associated with the at least one pilot sequence.

16. The data transmission method of claim 14, further comprising:
demodulating and decoding the detection result to acquire data sent by the transmitter;
wherein the data sent by the transmitter comprises at least one of the following:
user identity information;
service data;
information about the N pilots; or
information about the spreading sequence.

17. (canceled)

18. A data transmission device, comprising:
a memory configured to store a program; and
a processor configured to execute the program which, when executed by the processor, causes the processor to perform the following:
acquiring N pilot sequences and a spreading sequence, wherein at least one pilot sequence among the N pilot sequences has an association relationship with the spreading sequence, and N is an integer greater than 1;
processing to-be-sent data by using the spreading sequence to generate a to-be-sent data symbol; and
sending the N pilot sequences and the to-be-sent data symbol.

19. A data transmission device, comprising:
a memory configured to store a program; and
a processor configured to execute the program which, when executed by the processor, causes the processor to perform the data transmission method of claim 14.

20. A non-volatile storage medium, comprising a stored program which, when executed, causes the data transmission method of claim 1 to be performed.

21. A non-volatile storage medium, comprising a stored program which, when executed, causes the data transmission method of claim 14 to be performed.
